(19) United States
(12) Patent Application Publication
(10) Pub. No.: US 2018/0285991 A1
(43) Pub. Date: Oct. 4, 2018

(54) SYSTEMS AND METHODS FOR INTERACTIVE WEB-BASED PROCESSING OF REAL ESTATE TRANSACTIONS

(71) Applicant: FSBO System, LLC, Anchorage, AK (US)

(72) Inventor: Kirk Wickersham, Anchorage, AK (US)

(21) Appl. No.: 15/627,695

(22) Filed: Jun. 20, 2017

Related U.S. Application Data
(60) Provisional application No. 62/479,899, filed on Mar. 31, 2017.

(51) Int. Cl. G06Q 50/16; G06Q 30/02; G06Q 30/06; G06Q 30/08

(52) U.S. Cl. CPC G06Q 50/167; G06Q 30/08; G06Q 30/0613; G06Q 30/0201

(57) ABSTRACT

The present disclosure relates to computer systems and methods for interactive web-based processing of real estate transactions. In one embodiment the system includes a seller device, a server system, counselor device, and one or more home listing websites. In one embodiment, the server system provides an online interactive tutorial to the seller device having a corresponding dashboard on the counselor device that provides guidance for a real estate transaction.

### TECHNICAL FIELD

The present disclosure relates to computer systems and methods for interactive web-based processing of real estate transactions.

### BACKGROUND

Traditional real estate transactions often involve one or more agents (i.e., Real Estate Agents, Real Estate Broker, Real Estate Salesperson, Real Estate Associate Broker) tasked with representing the parties to the real estate transaction. For example, a seller may be represented by a seller agent, also known as a listing agent, and a buyer may be represented by a buyer agent.

In a traditional real estate transaction, the listing agent may list the property on a multiple listing service (“MLS”), advertise the listing, and the like. The responsibilities of the buyer agent include gaining access to the property the buyer wishes to view, relaying information regarding the property, and monitoring the state of the property as the buyer views it. Once a buyer indicates an interest in purchasing the property, the buyer and seller may enter into a negotiation that is intermediated by the listing agent and/or the buyer agent and results in a transfer of property from the seller to the buyer.

For their services, both the listing agent and the buyer's agent may each receive about 3% of the value of the property. Typically the fees paid to the buyer's agent and the seller's agent are both paid by the seller, and/or incorporated into the selling price.

Many problems are associated with a real estate transaction model that involves the use of seller and buyer agents. These problems include, for example, the financial burden placed on the seller, who typically pays about 6% of the value of the property (e.g., 3% to each of the buyer and seller agents) and typically does not receive as many services from the agent(s) as the buyer. Other problems faced by agents include conflict between contractual obligations and receiving financial compensation for their services. For example, a seller's agent may not have a contractual obligation for compliance, negotiation and closing services related to completion of the real estate transaction, as their primary obligation is to represent a seller's wishes. However, the primary loyalty of the seller's agent may remain with the real estate transaction, as they will only receive commission when the real estate transaction is completed.

Furthermore, the total time for the real estate transaction to be completed is also exacerbated by the delays caused by the use of multiple agents. For example, during a negotiation, a traditional real estate transaction precludes direct contract between the buyer and the seller. Instead, information is relayed via agents, in a manner that is inherently inefficient and may result in the miscommunication of information. Additionally, as viewing a real estate property may require establishing a time when the seller will not be present, and the listing and buyer agents and buyer will be present, it may require some time to schedule a viewing. In addition, agents typically accompany prospective buyers through a property, for example, to guard against pilfering and breakage. Prospective buyers, however, may obtain more consideration of a property without an agent's monitoring. Also, buyers may prefer to view a property without an agent. Thus, the agent may be counterproductive to the prospective buyer's property selection process. Additional delays are often due to real estate properties, in accordance with traditional techniques, being initially listed at inappropriate prices, which leads to greater delays in receiving offers, and more time spent in negotiating an appropriate price. This is due in part to a subjective pricing model commonly utilized in traditional real estate transactions. In particular, a seller's agent may first discover how much a seller expects a property to sell for, add a percentage (e.g., six percent), and then produce “comparable” sales that support that price, rather than objectively pricing the property based on similar properties available or recently sold in the market, as would be done in an objective comparative market analysis.

Furthermore, although it is estimated that about 90% of buyers initiate real estate transactions online by review real estate offerings using the internet prior to engaging a buyer agent, real estate transactions are typically processed and finalized using agents in the manner described above. Accordingly, there remains a need for electronic management of one or more of the steps described above in an effort to promote efficiency, reduce costs, and the like. Optionally, the electronic management may eliminate the need for one or more agents typically involved in the real estate transaction (e.g., seller agent, buyer agent). In such an embodiment, one or more parties to the real estate transaction may no longer be required to pay a commission.

There has been a long-felt but unsolved need to solve the problems and disadvantages of transacting real estate through an agent-driven process. The systems and methods of the present disclosure provide solutions to the problems and disadvantages discussed above.

### SUMMARY

Aspects of the present disclosure relate to systems and methods for an interactive web-based processing of real estate transactions. In one embodiment, a system includes a first device having a first graphical user interface and a first web browser, a second device having a second graphical user interface and a second web browser, and at least one server communicatively coupled to the first device and the second device via a network. The at least one server may include a non-transitory memory storing computer-readable instructions and at least one processor. The execution of the instructions, by the at least one processor, may cause the at least one server to provide one or more web pages to the first graphical user interface of the first device via the first web browser corresponding to an interactive tutorial of the at least one server for guiding a real estate transaction process; receive, via the first web browser, input from the first device associated with the one or more web pages provided to the first graphical user interface; identify, via a utility application embedded in the interactive tutorial, at least a portion of information from the received input matching one or more predetermined conditions; and provide one or more further web pages including the identified portion of information to the second graphical user interface of the second device via the second web browser corresponding to a dashboard for monitoring a transaction process of the first device.

In another embodiment a system may include a first device including a first graphical user interface and a first web browser, and at least one server communicatively coupled to the first device via a network. The at least one server may include a non-transitory memory storing computer-readable instructions and at least one processor. The execution of the instructions, by the at least one processor, may cause the at least one server to provide one or more web pages to the first graphical user interface of the first device via the first web browser corresponding to an interactive tutorial of the at least one server for guiding a real estate transaction process; receive, via the first web browser, input from the first device associated with the one or more web pages provided to the first graphical user interface; identify, via a utility application embedded in the interactive tutorial, at least a portion of information from the received input matching one or more predetermined conditions and store the identified portion of information in at least one database communicatively coupled to the at least one server.

### BRIEF DESCRIPTION OF DRAWINGS

Many aspects of the present embodiments may be better understood with reference to the following drawings. The components in the drawings are not necessarily to scale, emphasis instead being placed upon illustrating example embodiments:

FIG. 1 is a functional block diagram illustrating an example system for an interactive web-based processing of real estate transactions.

FIG. 2 is a signal flow diagram illustrating an example interactive web-based procedure for processing of real estate transactions, according to an aspect of the present disclosure.

FIG. 3A illustrates an example login feature of a webpage in accordance with an interactive web based guide for processing of real estate transactions from the perspective of a seller, according to an aspect of the present disclosure.

FIG. 3B illustrates an example login feature of a webpage in accordance with an interactive web based guide for processing of real estate transactions from the perspective of a seller, according to an aspect of the present disclosure.

FIG. 4 illustrates an example online interactive tutorial screen of an interactive web based guide according to an aspect of the present disclosure.

FIG. 5 is a flow chart illustrating an example method of processing real estate transactions in accordance with the online interactive tutorial shown in FIG. 4, according to an aspect of the present disclosure.

FIG. 6 illustrates one or more example sub-steps of the method shown in FIG. 5 according to an aspect of the present disclosure.

FIG. 7 illustrates an example online interactive tutorial screen in a sub-step of FIG. 6 according to an aspect of the present disclosure.

FIG. 8 illustrates an example online interactive tutorial screen in a sub-step of FIG. 6 according to another aspect of the present disclosure.

FIG. 9 illustrates an example online interactive tutorial screen in a sub-step of FIG. 6 according to another aspect of the present disclosure.

FIG. 10 illustrates an example online interactive tutorial screen in a sub-step of FIG. 6 according to another aspect of the present disclosure.

FIG. 11 illustrates one or more example sub-steps of the method shown in FIG. 5 according to an aspect of the present disclosure.

FIG. 12 illustrates one or more example sub-steps of the method shown in FIG. 4 according to an aspect of the present disclosure.

FIG. 13 illustrates an example online interactive tutorial screen in a sub-step of FIG. 12 according to an aspect of the present disclosure.

FIG. 14 illustrates one or more example sub-steps of the method shown in FIG. 5 according to an aspect of the present disclosure.

FIG. 15A illustrates an example online interactive tutorial screen in a sub-step of FIG. 14 according to an aspect of the present disclosure.

FIG. 15B illustrates an example online interactive tutorial screen in a sub-step of FIG. 14 according to another aspect of the present disclosure.

FIG. 15C illustrates an example online interactive tutorial screen in a sub-step of FIG. 14 according to another aspect of the present disclosure.

FIG. 15D illustrates an example online interactive tutorial screen in a sub-step of FIG. 14 according to another aspect of the present disclosure.

FIG. 15E illustrates an example online interactive tutorial screen in a sub-step of FIG. 14 according to another aspect of the present disclosure.

FIG. 15F illustrates an example online interactive tutorial screen in a sub-step of FIG. 14 according to another aspect of the present disclosure.

FIG. 16 illustrates one or more example sub-steps of the method shown in FIG. 5 according to an aspect of the present disclosure.

FIG. 17 illustrates an example online interactive tutorial screen in a sub-step of FIG. 16 according to an aspect of the present disclosure.

FIG. 18 illustrates one or more example sub-steps of the method shown in FIG. 5 according to an aspect of the present disclosure.

FIG. 19 illustrates one or more example sub-steps of the method shown in FIG. 5 according to an aspect of the present disclosure.

FIG. 20 illustrates an example online interactive tutorial screen in a sub-step of FIG. 19 according to an aspect of the present disclosure.

FIG. 21 illustrates an example login feature of a webpage in accordance with an interactive web based guide for processing of real estate transactions from the perspective of a counselor, according to an aspect of the present disclosure.

FIG. 22 illustrates an example additional login feature of a webpage in accordance with an interactive web based guide for processing of real estate transactions from the perspective of a counselor, according to an aspect of the present disclosure.

FIG. 23 illustrates an example webpage available to a counselor in accordance with an interactive web based guide for processing of real estate transactions, according to an aspect of the present disclosure.

FIG. 24A illustrates a portion of a webpage available to a counselor for monitoring seller information input via the online interactive tutorial, according to an aspect of the present disclosure.

FIG. 24B illustrates another example portion of the webpage available to the counselor for monitoring seller information input via the online interactive tutorial, according to an aspect of the present disclosure.

FIG. 24C illustrates another example portion of the webpage available to the counselor for monitoring seller information input via the online interactive tutorial, according to an aspect of the present disclosure.

FIG. 24D illustrates another example portion of the webpage available to the counselor for monitoring seller information input via the online interactive tutorial, according to an aspect of the present disclosure.

FIG. 24E illustrates another example portion of the webpage available to the counselor for monitoring seller information input via the online interactive tutorial, according to an aspect of the present disclosure.

FIG. 25A illustrates an example portion of an email transmitted to a counselor via the system responsive to particular seller information input via the online interactive tutorial, according to an aspect of the present disclosure.

FIG. 25B illustrates an example flyer according to an aspect of the present disclosure.

FIG. 26 illustrates an example webpage available to a counselor for monitoring seller information input via the online interactive tutorial, according to an aspect of the present disclosure.

FIG. 27 illustrates an example webpage available to a counselor in accordance with the online interactive tutorial, according to an aspect of the present disclosure.

FIG. 28 is a functional block diagram illustrating an example computer system, according to an aspect of the present disclosure.

### DETAILED DESCRIPTION

The present disclosure relates to computer systems and methods for interactive web-based processing of real estate transactions. In one embodiment, the systems described herein allow a seller to find a buyer themselves, eliminating the need for a seller's agent and/or a buyer's agent. Thus, interactive web based systems and methods of the present disclosure may be considered an agentless and automated technique for processing real estate transactions, which at least eliminates the use of a seller's agent (and in most examples, also eliminates use of a buyer's agent) from the process.

The systems and methods described herein may be applicable to all suitable real estate transactions, including but not limited to, selling a home. It is understood that the systems and methods described herein may equally apply to various real estate properties including, but not limited to, single or multifamily homes, condos, small rental properties, lots and raw land. In some examples, the systems and methods of the present disclosure may apply to large rental properties, commercial buildings and/or industrial properties. Not only do the systems and methods provide interactive web-based guidance to a seller throughout a real estate transaction process, the systems and methods also monitor the seller's input into a server system during the transaction process, store the data and input received from the seller, and send appropriate information to a separate counselor device. A counselor, through the counselor device, can interact with the seller throughout the real estate transaction process and provide guidance to the seller. Guidance for a real estate transaction process, as described herein, may refer to instructions for planning, preparation, marketing negotiating, and completing a real estate transaction. The interactive guide is also referred to herein as an online interactive tutorial. In general, the system, through the interactive guide and a utility application, receives input from a user (e.g., a seller), provides information to a user, tracks the user's information and progress, provides appropriate information to a counselor device so that a counselor can suitably interact with the user through the process (e.g., electronically and/or in person), and can direct the seller through the real estate transaction process. The interactive web-based tutorial works in conjunction with the counselor to provide guidance to the seller throughout the real estate transaction. The system may provide advantages over agent-driven processes, such as faster and more efficient completion of a transaction, elimination of commission fees, may increase the likelihood of completing the transaction and may also better adhere to any governmental regulations. The system has also demonstrated improved performance with respect to agent-driven processes. For example, properties for sale by users of the system may be on the market for about 32 days as compared with about 49 days for sellers represented by seller's agents. Users of the system may also have about a 75% chance of success in selling the property (i.e., completing the transaction) as compared with about a 65% chance of success for sellers represented by seller's agents. The example is based on the real estate market around Anchorage, Ak.

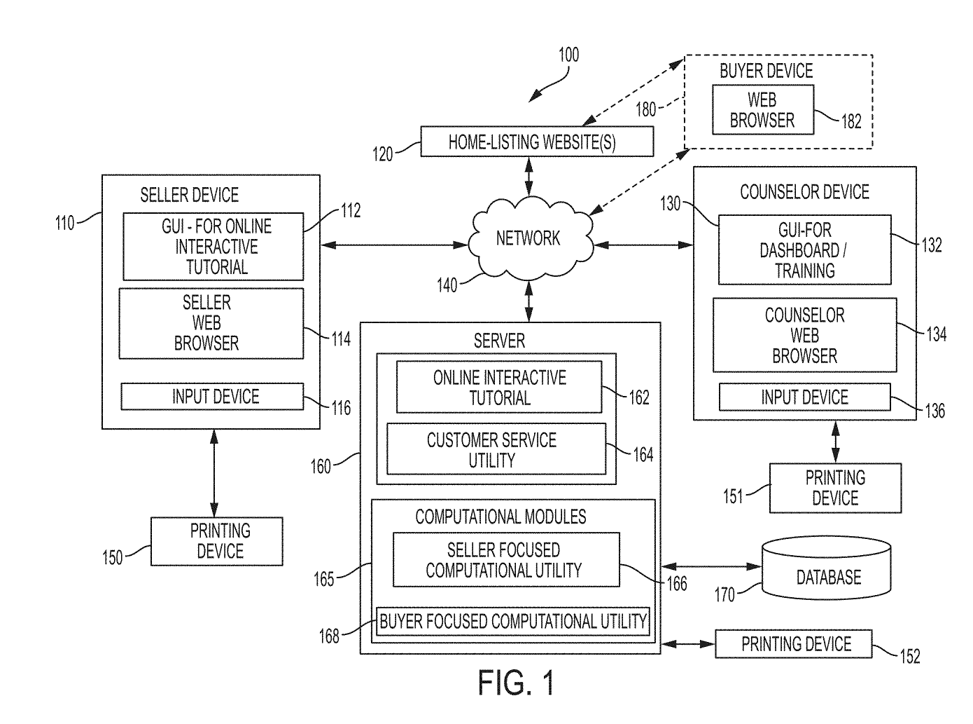

Turning now to FIG. 1, a functional block diagram illustrating an example system 100 for an interactive web-based processing of real estate transactions (referred to herein as system 100) is shown. System 100 may include seller device 110, one or more home listing websites 120, counselor device 130, at least one network 140, server 160 and at least one database 170. In some embodiments, the system 100 may include one or more optional buyer devices 180 including web browser 182 (any suitable software and/or application interfaces (APIs)). The optional buyer device(s) 180 may be communicatively coupled to the network 140. In one embodiment, the optional buyer device(s) 180 may be communicatively coupled to the seller device 110 via the network 140, but may be prohibited from communicating with the counselor device 130 or server 160. In some examples, system 100 may include one or more printing devices, such as one or more of printing devices 150-152. Although FIG. 1 illustrates one seller device 110 and one counselor device 130, in some examples, system 100 may include one or more seller devices 110 and one or more counselor devices 130.

Server 160 may include online interactive tutorial 162, customer service utility (CSU) 164, and various computational modules 165 including, for example, a seller-focused computational utility 166 and a buyer-focused computational utility 168. Server 160 may include one or more processors, or microprocessors coupled to one or more non-transitory memory devices and may be adapted to perform the functions described herein. Server 160 may be any special-purpose machine capable of storing and executing a set of computer-readable instructions (e.g., software) that specify actions to be taken to perform the functions described herein. The server 160 is one example of computer-readable storage medium. The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

Further, while only a single server 160 is illustrated, the term “server” shall also be taken to include any collection of machines that individually or jointly execute a set (or multiple sets) of instructions to perform any one or more of the methodologies discussed herein. For example, a first server may securely store online interactive tutorial 162, a second server may include CSU 164, and a third server may include the computational modules 165 including the seller-focused computational utility 166 and the buyer-focused computational utility 168. In some examples, at least one of two servers may be in different physical locations.

Online interactive tutorial 162 may interface with a seller, via seller device 110, to present queries to the seller, receive data and information related to a real estate property, process the received data and information, and present information to the seller to guide a real estate transaction for the real estate property based on the received data and information. For example, the online interactive tutorial 162 may receive, process, and present data and information related to establishing a selling goal, creating flyers, preparing MLS listing information, creating open house book materials, creating a self-guided tour and putting the real estate property in a selling condition. In one embodiment, the online interactive tutorial 162 may guide a seller thru clearly defined sequential steps that result in a completed real estate transaction. In another example, the online interactive tutorial 162 may allow a seller to conduct a portion of the real estate transaction, or select aspects of the sequential steps that the seller wishes to complete.

The online interactive tutorial 162 may be configured to receive seller input from seller device 110. Seller device 110 may include GUI 112, web browser 114, and input device 116. Seller device 110 may be configured to communicate with printing device 150, for printing material received from tutorial 162 via web browser 114. GUI 112 may be configured to display and interact with online interactive tutorial 162. In some examples, seller device 110 may include a separate input device 116 for entering information into one or more web pages provided by tutorial 162 via GUI 112. Seller input device 116 may include a keyboard, touch screen, mouse, and the like. In some examples, input device 116 may be part of GUI 112. Web browser 114 may include any suitable web browser for interacting with tutorial 162 via network 140. The data and information received by the online interactive tutorial 162 may be routed to the customer service utility 164, computational modules 165, database 170 and/or other components of the server 160.

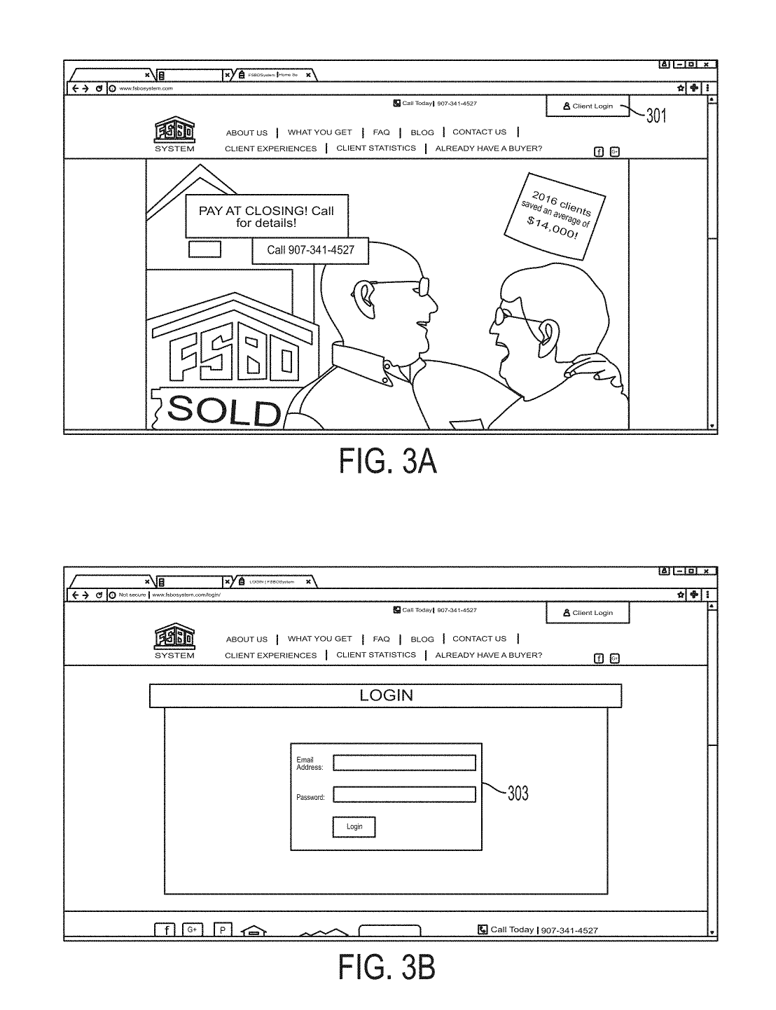

The online interactive tutorial 162 may also be configured to present information to seller device 110 (via web browser 114 and graphical user interface (GUI) 112), provide instructions and deliver electronic documentation to seller device 110. In one embodiment, the information presented to the seller device 110 (via the web browser 114 and GUI 112) is responsive to data and information received by the server 160 via the online interactive tutorial 162. As will be discussed in further detail below, in one embodiment the data and information displayed at the seller device 110 may include information obtained from one or more of home listing websites 120, seller devices 110, and/or counselor devices 130. In one embodiment, the online interactive tutorial 162 may provide one or more web pages relating to real estate transactions including the processing steps and graphical user interfaces illustrated in FIGS. 3A-20.

As discussed above, the data and information received by the online interactive tutorial 162 may be routed to the customer service utility (CSU) 164, computational modules 165, database 170 and/or other components of the server 160. The online interactive tutorial 162 may receive data and information from the seller device 110 and the like. In an optional embodiment, the CSU 164 may be configured to receive data and information from the home listing website 120. In one optional embodiment the CSU 164 may be configured to receive data and information related to the real estate property the seller wishes to transact in. The CSU 164 may process the received data and information and provide the processed data and information to one or more web pages (described herein as a dashboard) configured for display via GUI 132 of counselor device 130 (via web browser 134). The dashboard of a seller's marketing results and transactional progress, may be used by a counselor of counselor device 130 in assisting a seller of seller device 110 in completing a real estate transaction. A counselor, as used herein, refers to a specially-trained, real estate professional who assists the seller in selling their home. In one embodiment, counselors may be licensed by a state, and may be members of the Board of Realtors.

Counselor device 130 may include GUI 132, web browser 134, and input device 136. Counselor device 130 may be configured to communicate with printing device 151, for printing material received from CSU 164 via web browser 134. GUI 132 may be configured to display and interact with CSU 164. In some examples, counselor device 130 may include a separate input device 136 for entering information into one or more web pages provided by CSU 164 via GUI 132. In some examples, input device 136 may be part of GUI 132. Counselor input device 136 may include a keyboard, touch screen, mouse, and the like. Web browser 134 may include any suitable web browser for interacting with CSU 164 via network 140. Counselor device 130 may also be configured for retrieving and/or interacting with one or more tutorials for training, via server 160 over network 140. In some examples, a counselor, via counselor device 130, may create a seller's profile, and then the counselor and/or the seller may populate CSU 164 with data, marketing materials and/or other information based on the seller's profile. In some examples, a seller's use of their savings and/or a seller's goal may be transmitted to the CSU dashboard, so the counselor may refer to it while coaching or encouraging a seller throughout the real estate transaction. In some examples, the counselor may provide the seller with access/permissions to the online interactive tutorial 162 and create the seller's profile on CSU 164. Once the profile is created, the counselor may interact with CSU 164. In one embodiment, the counselor's graphical user interface 132 may be different from the seller's version of online interactive tutorial 162 displayed on graphical user interface 112 on the seller's device 110. In some examples, the counselor may, via counselor device 130, view and monitor the seller's progress on online interactive tutorial 162, including monitoring, for example, the creation of a flyer.

In some examples, CSU 164 may be embedded in online interactive tutorial 162. CSU 164 may be a monitoring program, configured as a communications link between the seller and a counselor to provide helpline functions, such as troubleshooting or online assistance, via email, telephone or video conference. In some examples, CSU 164 may be configured as a data retrieval and collection component that may provide information, calculations, analysis, or output to counselor device 130 via the dashboard. In some examples CSU 164 may be configured to receive seller input via tutorial 162, retrieve and collect additional real estate data and information from tutorial 162, process the information and data, and output information, data, calculations and analysis to at least one seller device 110 or at least one counselor device 130. In one embodiment, the data analysis and calculations may be done by the computational modules 165. In such an embodiment, the CSU 164 may be communicatively coupled to the computational module 165. In some optional examples, CSU 164 may use home-listing websites 120 to data mine for additional real estate data and information.

The computational modules 165 may include a seller focused computational utility 166 and a buyer-focused computational utility 168. The seller focused computational utility 166 may be configured to calculate and/or determine various seller statistics, and include for example, algorithms to calculate statistics such as Compensation, Seller's Savings, Target Closing Date, Target on Market Date, Show Condition and Adjusted CMA (all of which are discussed further below). In general, computational modules 165 (including utilities 166, 168) may be configured to execute a set of computer-readable instructions (e.g., software) that specify actions to be taken to perform the functions described herein.

The buyer-focused computational utility 168 may be configured to keep statistics of what prospective buyers actually do during a seller's marketing process. For example, the statistics may incorporate various measures of marketing effectiveness, pricing viability and show condition. These measures may include flyer loss from a brochure box (which measures marketing effectiveness), visitors to open houses (which measures the viability of the seller's asking price), and return visitors (which measures the show condition, the “likeability” of the house). These statistics are discussed further below.

While the buyer-focused computational utility 168 and seller-focused computational utility 166 are illustrated as separate computational utilities, in an alternative embodiment, the buyer-focused and seller-focused computational utilities may be incorporated into a single computational utility. Alternatively, each of the buyer-focused and seller-focused computational utilities may include one or more computational sub-utilities.

The server system 160 may also include at least one database 170. The database 170 may be a separate component or one that is integrated into the server system 160. The database 170 may include any device or combination of devices suitable for storing software for online interactive tutorial 162 (e.g., web pages), data for algorithms/mid-course correction(s), data for buyer-focused computational utility 168, as well as any information, documentation, videos, data, tutorials or instructions (e.g., software) for performing any one or more of the functions described herein. In one embodiment, the database 170 may store information related to a real estate transaction and/or property received from seller device 110, counselor device 130, and/or home listing website 120. In one embodiment, a record stored in the database 170 may be referred to as a seller profile. Data and information stored in the database 170 may be retrieved by one or more of computational modules 165 to perform buyer-focused and seller-focused statistics.

One or more home-listing websites 120 may be included in system 100. Seller device 110 and counselor device 130 may each communicate and interact with various home-listing websites 120 which may be connected to network 140. Examples of home-listing websites may include, without being limited to, local MLS, Realtor.com, Zillow and Trulia. In some examples, a counselor via counselor device 130 may retrieve information related to the real estate property of the real estate transaction from one or more home-listing websites 120, including for example, data and information related to the real estate property's history and that of comparative real estate properties. Optionally, a server 160 may also retrieve information from the one or more home-listing websites 120. The data and information collected from the one or more home-listing websites 120 may be utilized and processed by one or more of the online interactive tutorial 162, customer service utility 164, and computational modules 165 to provide data and information to seller device 110 and/or counselor device 130.

In one embodiment, the system 100 may also include one or more optional buyer devices 180 that are communicatively coupled to the network 140. The buyer may access and initiate a real estate transaction by visiting the home-listing websites 120 via software, application interfaces, and webpages 182 communicatively coupled to the network 140. System 100 components may be communicatively coupled to one another via one or more networks 140. A network 140 may be any plurality of completely or partially interconnected computers or computer components wherein some or all of the computers or components are able to communicate with one another. Connections may be wired in some cases (e.g., via wired TCP connection or other wired connection) or may be wireless (e.g., via a WiFi network connection). Any connection through which at least two computers or components may exchange data can be the basis of a network 140. Furthermore, separate networks 140 may be able to be communicatively coupled such that one or more computers or components within one network may communicate with one or more computers in another network 140. In such a case, the plurality of separate networks 140 may optionally be considered to be a single network. Network 140 may include, for example, a private network (e.g., a local area network (LAN), a wide area network (WAN), intranet, etc.) and/or a public network (e.g., the Internet). In one embodiment, one or more seller devices 110, counselor devices 130, and servers 160 may be communicatively coupled via one or more networks 140.

One or more printing devices 150, 151, 152, may be included to print information, documentation or screen shots, etc. In some examples, information, documentation or screen shots may be displayed on seller device 110, counselor device 130 or preprinted and delivered to a seller or counselor.

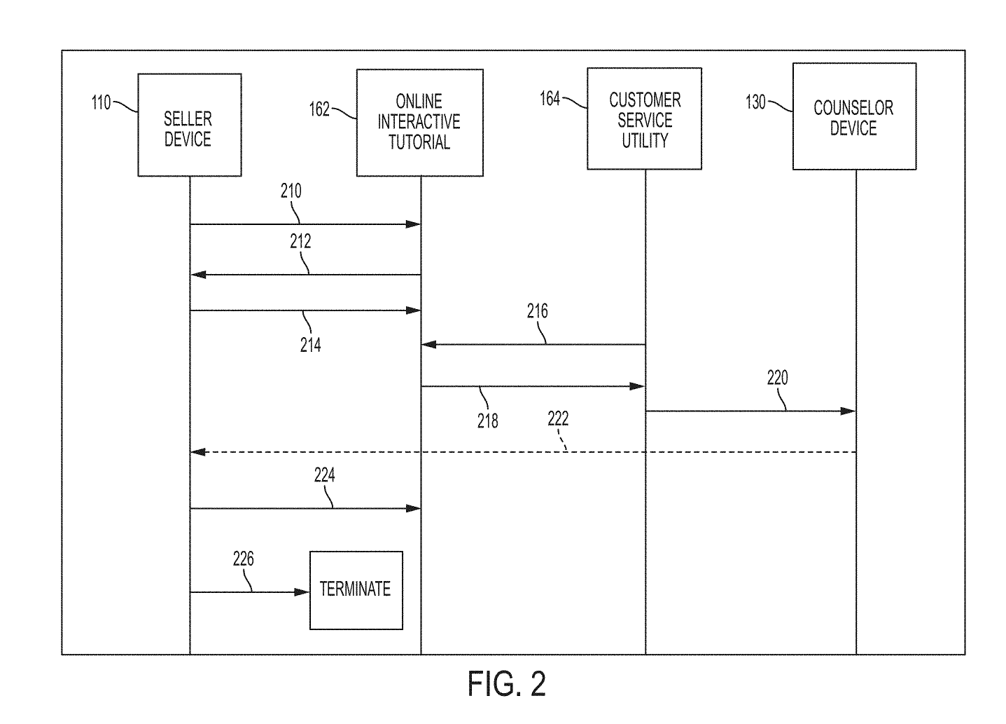

Turning now to FIG. 2, a signal flow diagram is shown of an example interactive web-based procedure for processing of real estate transactions associated with system 100 (FIG. 1), according to an aspect of the present disclosure. In FIG. 2, it is understood that some of the steps may be performed by system 100 concurrently with other steps or a combination of steps, or may be performed in a different sequence than shown. At Step 210, seller device 110 may initiate the process by sending a request to online interactive tutorial 162 via web browser 114 of seller device 110. At Step 212, online interactive tutorial 162 may initiate a presentation of one or more web pages on GUI 112 via seller web browser 114 of seller device 110. At Step 214, seller input may be sent from GUI 112 (and/or input device 116) to online interactive tutorial 162.

At Step 216, CSU 164 may collect seller input from online tutorial 162, and identify relevant information for counselor device 130. (Although not shown, CSU 164 may also identify and retrieve any information for storage in database 170 that may be useful by system 100). At step 218, CSU 164 may retrieve the identified information from interactive tutorial 162. At Step 220, CSU 164 may send information, any calculations (as performed by computational modules 165), analysis, or output to GUI 132 of counselor device 130 for presentation as a dashboard, via web browser 134. At Step 222, counselor device 130 may, optionally, communicate with seller device 110.

At Step 224, seller device 110 may send a request to logout of tutorial 162. At Step 226, tutorial 162 may terminate the process. The process may repeat any of Steps 212-222 in any sequence, and any number of times, before the process is terminated at Step 226. Communications and data may be sent from one component to any other component via network 140. One or more of steps 212-222 may be repeated according to a multistep online interactive tutorial for processing of the real estate transaction, described further below with respect to FIG.

FIGS. 3A-20 illustrate an embodiment of the real estate transaction process utilizing interactive web-based processing of real estate transactions, from the perspective of a seller. Using seller device 110 and seller input device 116, the seller may navigate to a website via web browser 114 containing a link to GUI 112 displaying the online interactive tutorial 162. In one embodiment, as displayed in FIG. 3A, upon navigating to the website, a seller may initiate login via login selector 301 to the online tutorial via a security system requiring authentication of the seller's identity via identity input fields 303 (see FIG. 3B). To verify the seller's authenticity, the seller device 110 may be in communication with the server 160 to determine whether the information input by the seller identity input fields 303 matches that stored in the record database 170.

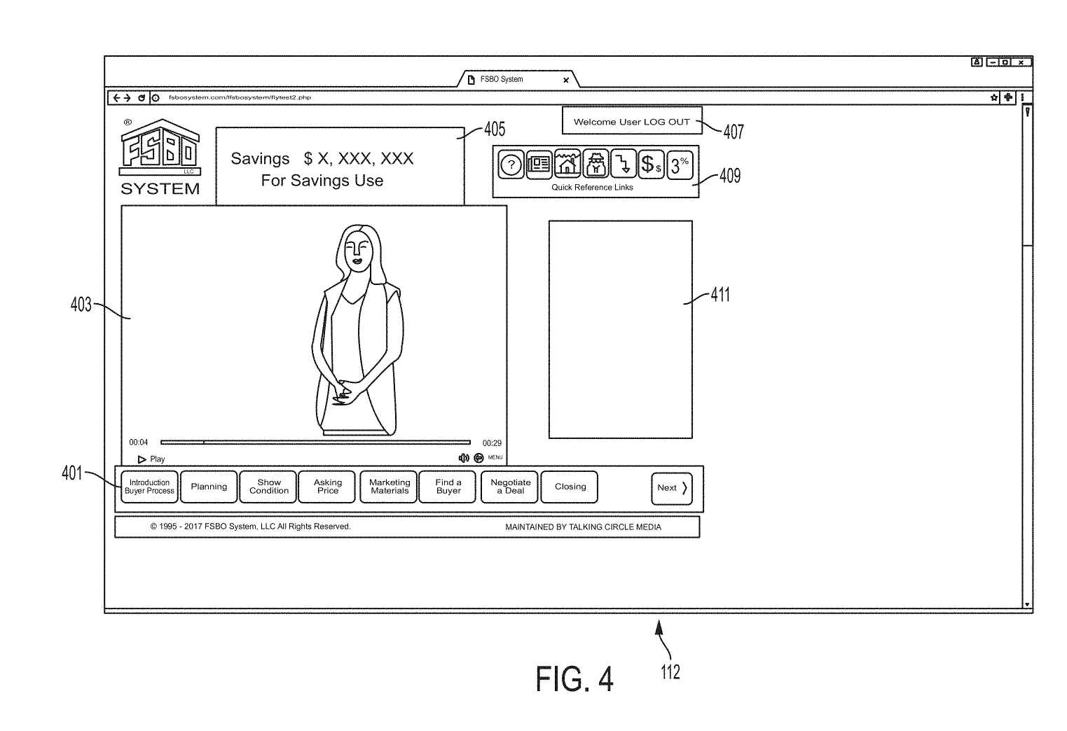

As illustrated in FIG. 4, once the seller's information is verified by system 100, online interactive tutorial 162 may be displayed via GUI 112. The online interactive tutorial 162 may be displayed as a part of a graphical user interface having one or more distinct areas. Although buttons, click boxes, text boxes, drop down menus and the like are depicted herein, any suitable alternatives such as sliders, radio buttons, tabs, etc. may be used in connection with the depicted webpages. Additionally, the areas of the online interactive tutorial 162 may be rearranged in any suitable organization and one or more of the areas discussed below may be optional.

A menu bar area 401 of the online interactive tutorial 162 may display the various steps associated with the tutorial for the real estate transaction process. The steps associated with the tutorial may include an introduction buyer process step, a planning step, a show condition step, asking price step, marketing materials step, a find a buyer step, a negotiate a deal step, and a closing step. In one embodiment, a computer mouse that hovers above the icon associated with a step in the menu bar area 401 may display additional sub-steps associated with each step (discussed below). Selection of a step and/or sub-step by clicking or touching may cause one or more of the other areas of the online interactive tutorial 162 to update including the video area 403.

The video area 403 may be configured to display a video providing instructional information to the seller of the online interactive tutorial 162 regarding the real estate transaction process. The video area 403 may also display text and emit sound related to the real estate transaction process.

The online interactive tutorial 162 may also contain a goals area 405, configured to display the estimated savings and possible uses of the estimated savings from using the real estate transaction process associated with the online interactive tutorial 162. The goals area 405 may be updated based on information received from the interactive input area 411 (discussed below) of the online interactive tutorial 162. The online interactive tutorial 162 may also contain a sign-in/out area 407 that displays information regarding login, logout and the user name.

The online interactive tutorial 162 may also contain a quick reference area 409 that displays one or more icons. Upon clicking or selecting one of the displayed icons, in one embodiment, the seller may be redirected to a different website, webpage and/or other portions of the online interactive tutorial 162 may be updated with different fields.

The interactive input area 411 may include textbooks, radio buttons, drop-down selection menus and the like that ask the seller to input information regarding the real estate transaction. The prompts and/or fields displayed in the interactive input area 411 may update with information received from the CSU 164. The interactive input area 411 may display different questions, prompts, or utilities based on the step of the real estate transaction process. The interactive input area 411 may include a print button or other selectable button that provides a link to a printable document. The printable document may provide more information about any questions and answers asked in the interactive input area 411. Examples of the interactive input area 411 in connection with various stages of the real estate transaction process are discussed below. Information input into the interactive input area 411 may be transmitted from by the online interactive tutorial 162 to the CSU 164.

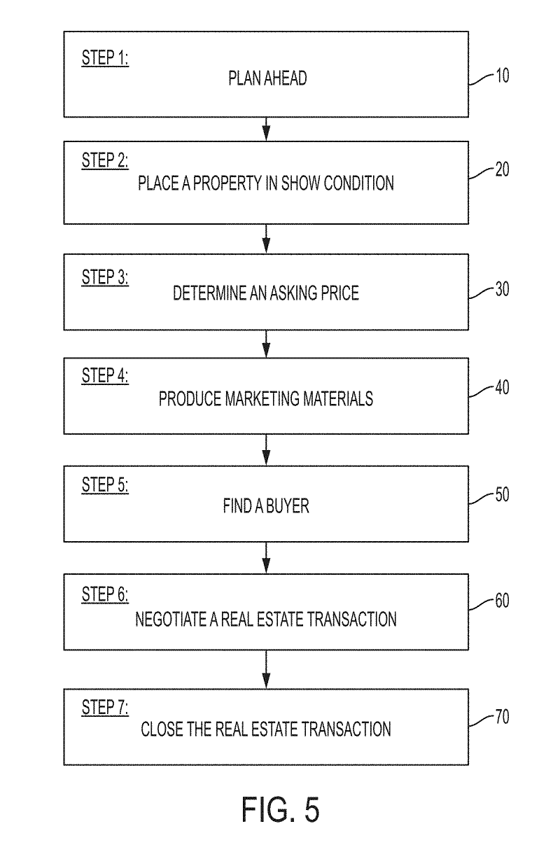

Turning now to FIG. 5, which illustrates a seven step process for a web-based real estate transaction processing procedure implemented by the online interactive tutorial 162 described herein. The steps presented in FIG. 5 may correspond to those displayed in the menu bar area 401 of the online interactive tutorial 162. The online interactive tutorial 162 may provide instructions to the seller to Step 1: Plan Ahead 10; Step 2: Place a Property in Show Condition 20; Step 3: Determine an Asking Price 30; Step 4: Produce Marketing Materials 40; Step 5: Find a Buyer 50; Step 6: Negotiate a Real Estate Transaction 60; and Step 7: Close the Real Estate Transaction 70.

As a part of Step 1: Plan Ahead 10, the server system 160 may receive seller input from seller device 110 and may support the seller's motivation to complete the real estate transaction by calculating various estimated savings, determining what a seller will do with the savings, producing manuals, and the like. In one embodiment Step 1: Plan Ahead 10, may involve displaying and receiving data and information via interactions between the server 160, and seller devices 110. For example, in one embodiment the estimated savings may be computed by computational module 165.

As a part of Step 2: Place a Property in Show Condition 20, the online interactive tutorial 162 may provide guidance for placing the property in show condition. In one embodiment, at least a part of the guidance displayed on the seller device 110 as a part of the online interactive tutorial 162 may be based on the data and information provided to the server system 160 by the seller as a part of Step 1: Plan Ahead 10.

As a part of Step 3: Determine an Asking Price 30, the online interactive tutorial 162 may assist a seller in determining an asking price that reflects fair market value, and may implement a selling goal for the seller. Determining an asking price may involve tutorial 162 causing computational modules 165 to perform calculations, tutorial 162 causing data and information related to the calculations conducted by the computational modules 165 to be displayed via GUI 112. CSU 164 may parse tutorial 162 to extract data and information from the seller's input to the tutorial 162.

As a part of Step 4: Produce Marketing Materials 40, the online interactive tutorial 162 may provide a seller with marketing materials, obtained from database 170, the seller may then print.

As a part of Step 5: Find a Buyer 50, the online interactive tutorial 162 may assist the seller in finding a buyer for the real estate property. In some embodiments the Find a Buyer 50 step may involve conducting regular open houses and making mid-course corrections until a buyer is found. In some embodiments, online interactive tutorial 162 may present suggested mid-course corrections to GUI 112. In some embodiments, the mid-course corrections may be determined by buyer focused computational utility, and may be based on data analysis performed by the computational modules 165, as well as any input received from the counselor device 130.

As a part of Step 6: Negotiate a Real Estate Transaction 60, the online interactive tutorial 162 may include providing guidance to the seller for negotiating directly with a buyer to initiate a real estate transaction. In one embodiment, the guidance may be stored in the database 170. The negotiate step 60 may be conducted without the presence of a buyer's agent.

As a part of Step 7: Close the Real Estate Transaction 70, the online interactive tutorial 162 may guide a seller through opening escrow, due diligence, home inspection and appraisal. This may involve providing via the tutorial 162 one or more electronic documents stored in the database 170.

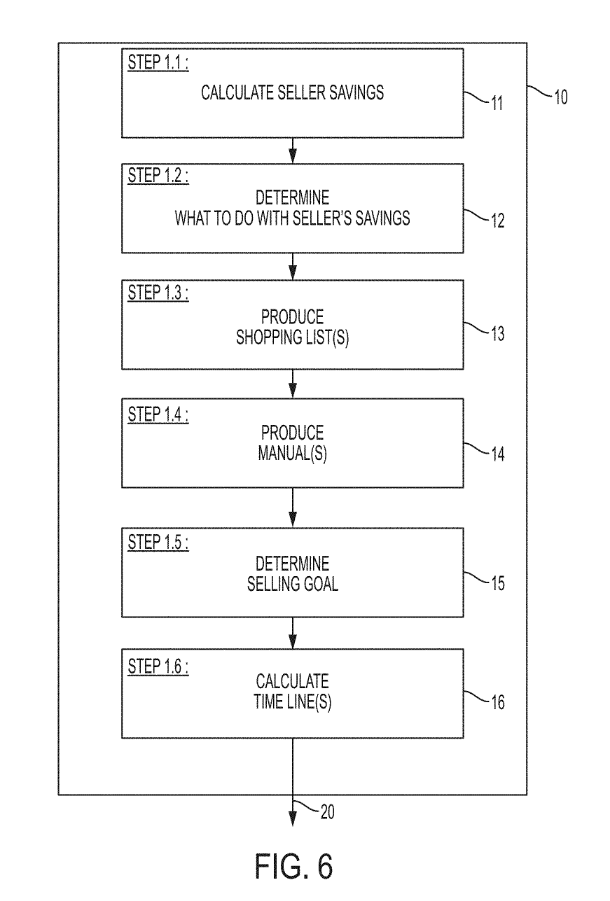

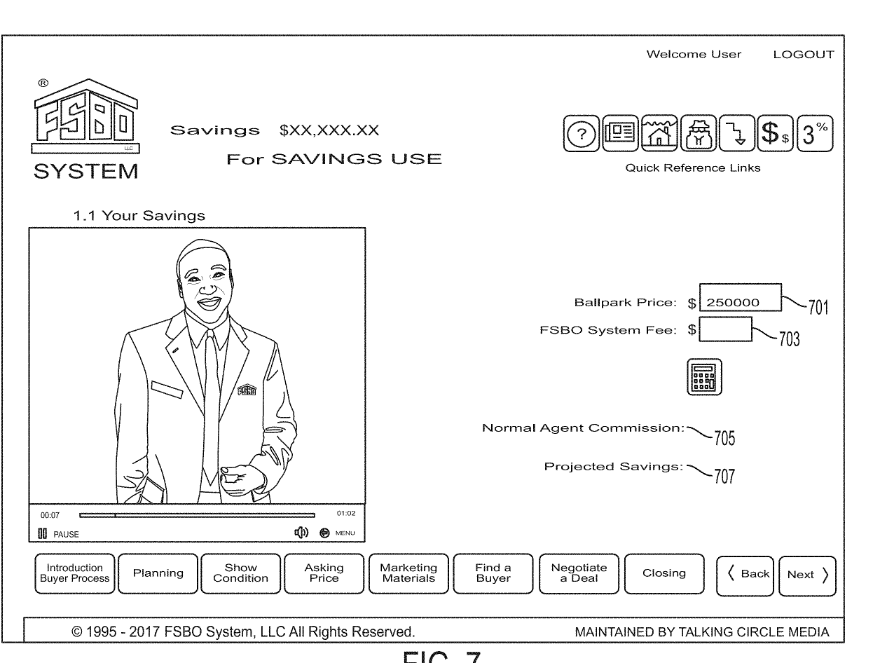

Each of the seven steps presented in the interactive online tutorial 162 and illustrated in FIG. 5 may include one or more sub-steps, as discussed below in relation to FIGS. 6-20.

In particular, as is illustrated by FIG. 6, an example process for Step 1: Plan Ahead 10 may include various sub-steps including, for example, Step 1.1: Calculate the seller's savings 11, Step 1.2: Determine what to do with the seller's savings 12, Step 1.3: Produce shopping lists 13, Step 1.4: Produce manuals 14, Step 1.5: Determine a selling goal 15, and Step 1.6: Calculate a time line 16. The sub-steps may involve receiving data and information from the seller, transmitting the information to the server 160, and receiving updates to the online interactive tutorial 162 from the server 160. The updates may then guide the prompts presented to the seller as a part of the online interactive tutorial 162.

For example, as illustrated in FIG. 7, after selecting Step 1: Plan Ahead (see step 10 in FIG. 5) from the menu bar area 401 and more particularly Step 1.1: Calculate Seller's Savings (see 11 in FIG. 6), the interactive input area 411 may request that a seller input an estimate of the price the seller desires to list the house at field 701, and in response the system may automatically calculate and/or display the fees paid to the system in area 703, commissions received by an agent in a traditional real estate transaction in area 705, and the savings afforded by the presented real estate transaction process in area 707. Typically, the savings afforded by the presented real estate transaction process is equivalent to the difference between the commissions received by an agent in a traditional real estate transaction (e.g., 6% of the transaction value) and the fees paid to the system. In one embodiment, the savings may be calculated by the computational modules 165 of the server 160 in response to information input into the online interactive tutorial 162.

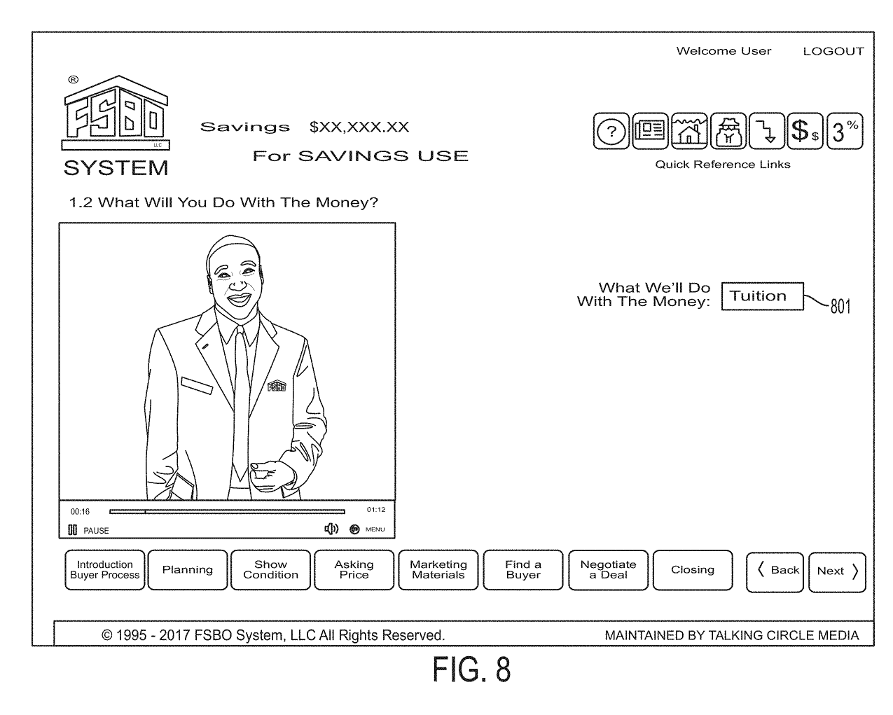

Additionally, as illustrated in FIG. 8, as a part of Step 1: Plan Ahead 10 and more particularly, Step 1.2: Determine what to do with Seller's Savings 12, a seller may be requested to input what they intend to do with the savings afforded by the presented real estate transaction process in a field 801. The savings value of step 1.1 and the intended use of step 1.2 may be used to update the goals area 405, thereby providing motivation for a seller to continue using the systems and methods described herein. Whereas some sellers may be motivated simply by money as an abstract concept, others may be motivated by what the money will buy. Online interactive tutorial 162 may provide examples of possible applications of the savings, such as college tuition, a trip to Europe, a new vehicle, a new boat etc. In some embodiments, the examples may be provided by previous sellers.

In some embodiments, the seller's inputted text information (related to Step 1.2) may be displayed in the goals area 405 throughout the use of the online interactive tutorial 162, and may also be transmitted to the CSU 164, counselor device 103, stored in database 170, and integrated into the materials produced in Step 1.4: Produce Manual(s) 14 (discussed below).

As a part of Step 1: Plan Ahead 10 and more particularly Step 1.3: Produce Shopping List(s) 13, the online interactive tutorial 162 may provide the seller with one or more shopping lists representative of one or more suggested goods the seller may need to purchase during the real estate transaction process. Online interactive tutorial 162 may display, via GUI 112, a description of the one or more shopping lists and their purpose. Shopping list(s) may be displayed on GUI 112 or seller web browser 114. GUI 112 may display a print button linked to print shopping list(s) via printing device 150. Step 1.3: Produce Shopping List(s) allows a seller to make one trip to buy everything they may need for the entire real estate transaction process. In one embodiment, printed copies of the Produced Shopping Lists may be kept in the Seller's Manual.

As a part of Step 1: Plan Ahead 10 and more particularly, Step 1.4: Produce Manual(s) 14, the online interactive tutorial 162 may produce one or more manuals for a seller to use as a reference and/or guide to the real estate transaction process by using printed documentation. In an example, two three-ring binders with clear plastic insert covers and divider tabs may be used for the Produced Manuals. One may be a Seller's Manual, and the other may be an Open House Book. The GUI 112 may display one or more print buttons integrated into the online interactive tutorial 162 and linked to print one or more electronic documents for either the Open House Book or the Seller's Manual, via printing device 150. Over the course of online interactive tutorial 162, a seller may use the binders to contain memos, documents, worksheets and similar information and tools. In one embodiment, the memos, documents, worksheets and similar information and tools may be created and stored electronically at the seller side on a local memory of the seller device 110.

Sellers who use a Seller's Manual as described by the process of the present disclosure may be better organized and remember more of the online interactive tutorial 162. The use of a seller's manual may enable a seller to show a property and negotiate a deal without the presence of any agent, thus eliminating the need for one or more of a listing agent and a buyer's agent. In one embodiment, a Seller's Manual may have a coversheet displaying a Seller's Savings (see Step 1.1) and What to do With the Money (see Step 1.2) and may contain Produced Shopping List(s) (see Step 1.3). One or more other documents may be added to the Seller's Manual over the course of online interactive tutorial 162.

The Open House Book may provide information a buyer may need to feel comfortable making an informed offer, and may replace the inherently inefficient conventional process of agents relaying information which can result in miscommunication. In one embodiment, Open House Book may contain property disclosures, title documents, deeds, covenants and homeowner's association materials as applicable, and similar detailed information that a prospective buyer might need to make an informed offer. It may also contain one or more copies of a “buyer's packet” that may include completed state and federally-required disclosures, and a streamlined Form Purchase and Sales Agreement (optionally referred to as an “EZ Form Purchase and Sales Agreement” or an “Easy Form Purchase and Sales Agreement”) that a prospective buyer may use to make an offer. In another embodiment, a counselor may contact a title agency to obtain a copy of the deed, an as-built survey and the covenants and deed restrictions, if any, and may provide the documents to the seller for inclusion in the Open House Book. Accordingly, a counselor may utilize the counselor input device 136 to transmit information to the customer service utility 164. The customer service utility 164 may then update the online interactive tutorial 162 with information that is then provided to the seller via the GUI 112.

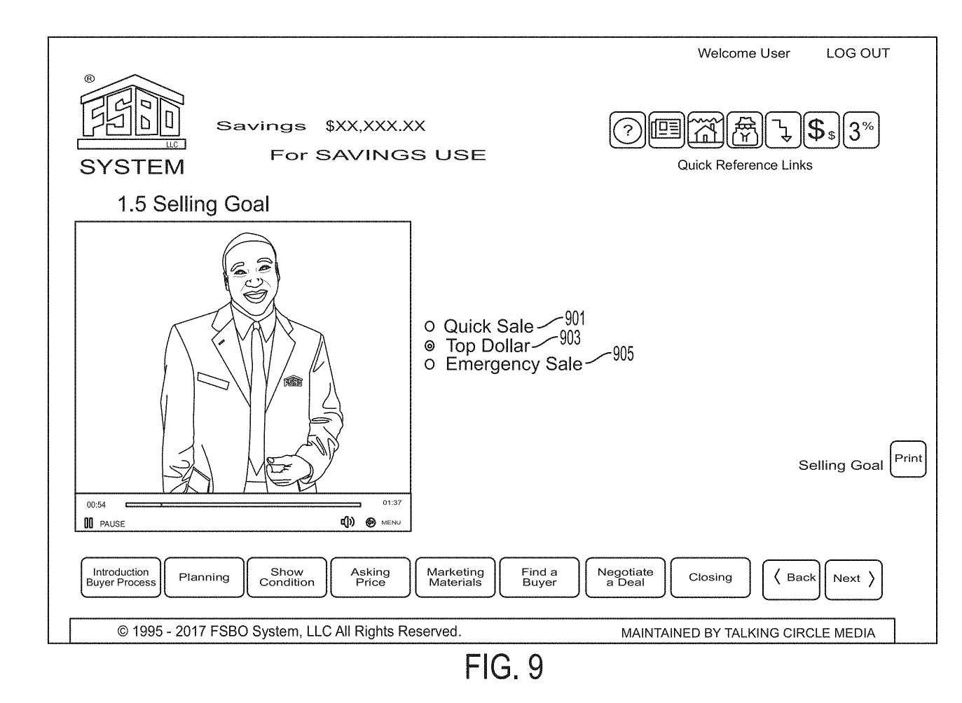

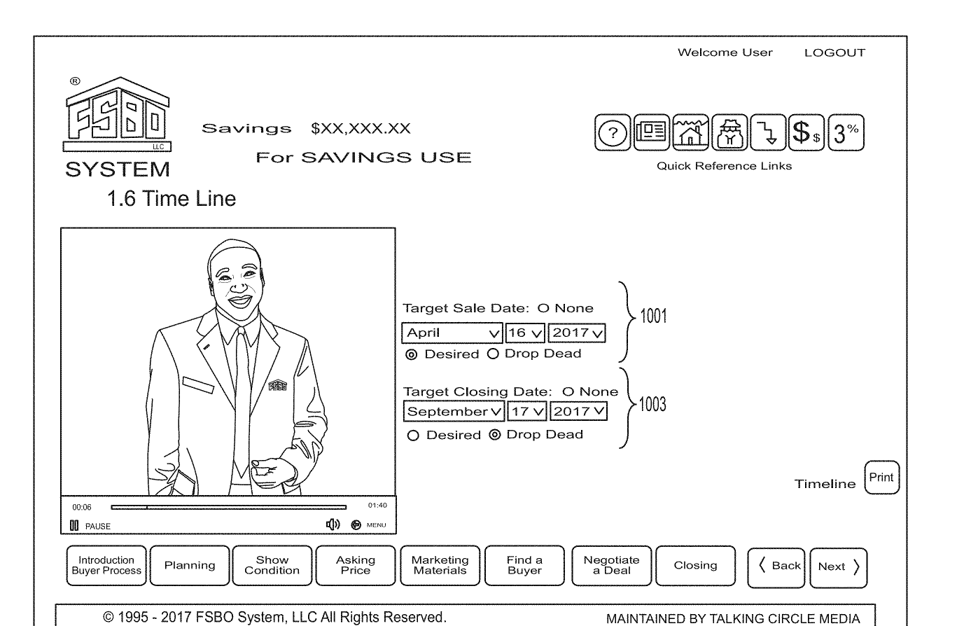

As illustrated in FIG. 9, as a part of Step 1: Plan Ahead 10 and more particularly, Step 1.5: Determining a Selling Goal 15, the online interactive tutorial 162 may establish the seller's primary goal for the real estate transaction. By setting a primary goal, multiple sellers (i.e., family members) are required to confront, and resolve, the tradeoff between price and marketing time, and may focus their attention on what has a higher priority, time or money. A seller's selling goal may inform and drive a seller's efforts and the counselor's advice during the marketing period, and any advice provided by a counselor. In the embodiment illustrated in FIG. 9, a seller may be requested to select their goal for the real estate transaction. For example, the seller may select from “Quick Sale” field 901 where the goal is to quickly divest the real estate property, “Top Dollar” field 903 where the goal is to make the most money from their real estate transaction, or “Emergency Sale” field 905 where the goal is to divesting the real estate property within 45 days. A goal of Top Dollar may include putting the home in top show condition, and a willingness to accept a 60 to 90 day marketing period, in an effort to receive a home price at the top range. For a Quick Sale goal, for example, the property may be placed in good show condition, and aim for a sale within 60 days. For an Emergency Sale goal, for example, the property may be advertised below the market price, placed in the top showing condition, require active marketing efforts. Additionally, a commission (e.g., 3%) may be offered to a buyer's agent. In examples, including a seller wanting a selling goal that is a blend of two or more goals, the seller may select an asking price in the middle of the range. A seller may change the Determined Selling Goal at any time. After a seller inputs the Determined Selling Goal, the information is transmitted from the seller device 110 to the server 160 and then may be transmitted to the counselor device 130, so that the selling goal is displayed in dashboard 134 and available for use by a counselor.

As a part of Step 1: Plan Ahead 10 and more particularly, Step 1.6: Calculate Time Line(s) 16, the online interactive tutorial 162 may be used to manage the timing of marketing and closing procedures. In a traditional real estate transaction process having agents, timelines are not typically used to manage the process. Instead, a seller may tell their agent of a looming date, and the agent's only technique is a dramatic price drop. By contrast, in the systems and methods described herein, both the seller and the counselor know of dates early in the process, and can plan ahead to eliminate the need for a price drop. As illustrated in FIG. 10, as a part of Step 1.6: Calculate Time Line(s) 16, the online interactive tutorial 162 may request a seller to enter information regarding the target sale date in a first area 1001 and closing date in a second area 1003 for the real estate transaction.

In an alternative embodiment, the interactive input area 411 may include an additional calculator. Selecting the calculator may calculate one or more time lines for the real estate transaction process, based on the information provided by the seller through the interactive input area 411 in connection with FIG. 10. In one embodiment, the calculator may calculate one or more of an On Market Date, Closing Date and A Sale Date. The On Market Date may refer to the date of a first open house. The Closing Date may refer to the date to close on a new house a seller may be buying. The Sale Date may refer to the date a seller expects to leave town for a new job. The dates comprising the timeline generated in Step 1.6 may drive the actions of both the counselor and the seller. In some examples, a seller may not have a specific For Sale Date or Closing Date (which may also be important information for both the seller and the counselor). In an example, a seller may select and print out the various time lines, via printing device 150, and add them to the Seller's Manual. In another example, Calculated Time Lines may also be displayed on dashboard 132, so a counselor can coach the seller to meet the Calculated Time Lines and achieve their Determined Selling Goal.

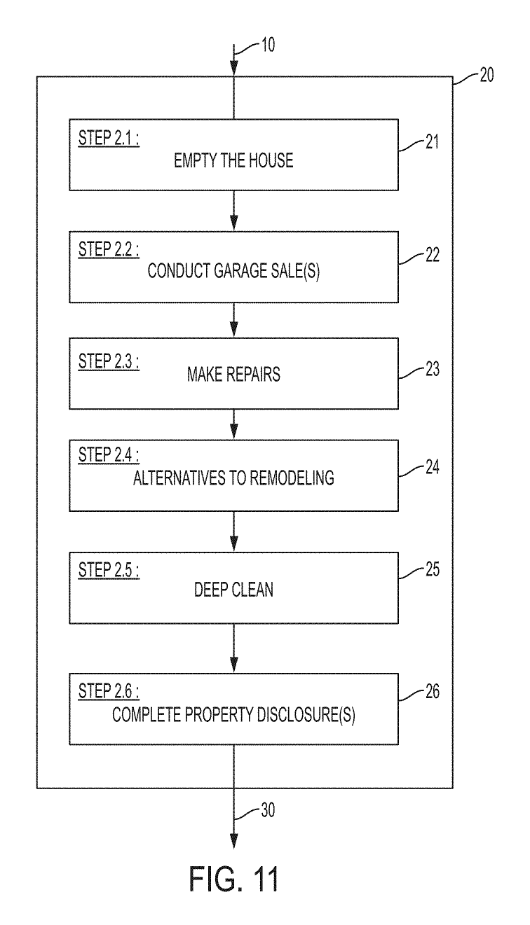

In one embodiment, after the completion of Step 1: Plan Ahead 10, the seller may proceed to the second step of the online interactive tutorial 162, namely, Step 2: Place a Property in Show Condition 20. As is illustrated by FIG. 11, an example process for Step 2: Place a Property in Show Condition 20, may include various sub-steps including, for example, Step 2.1: Empty the House 21, Step 2.2: Conduct Garage Sale(s) 22, Step 2.3: Make Repairs 23, Step 2.4: Alternatives to Remodeling 24, Step 2.5: Deep Clean 25, and Step 2.6: Complete Property Disclosure(s) 26. The sub-steps involved in Step 2: Place a Property in Show Condition 20 may involve receiving data and information from the seller, transmitting the information to the server 160, and receiving updates to the online interactive tutorial 162 from the server 160. The updates may then guide the prompts presented to the seller via GUI 112 as a part of the online interactive tutorial 162. Additionally, a counselor having counselor device 130 may contribute towards the processing step of Placing the Property in Show Condition 20 before, during, and/or after a home visit.

In Step 2.1: Empty the House 21, the online interactive tutorial 162 may present methodology and instructions to seller via GUI 112 for emptying the real estate property. As opposed to traditional real estate transaction process, the systems and methods described herein, in some examples, may advocate an empty house, as an empty house condition may allow a buyer to envision their own personalization (e.g., furniture, decorations, etc.) in the real estate property.

In an effort to empty the house, the seller may hold a garage sale, in accordance with electronic guidance from the online interactive tutorial 162 in Step 2.2: Conduct Garage Sale(s) 22. In some embodiments, a garage sale may be optional.

As a next step, the online interactive tutorial 162 may guide the seller to perform maintenance and repairs to the real estate property in Step 2.3: Make Repairs 23. In some embodiments, a counselor may assist the seller in identifying the maintenance and repairs necessary to the property. A seller may retrieve a Repair Checklist from the online interactive tutorial 162 and print, complete and catalogue (or electronically complete and store) the checklist into the seller's manual.

In connection with a counselor, the online interactive tutorial 162 may assist the seller in recognizing, anticipating, and handling functional issues (i.e., issues involving an obsolete layout or floorplan) in Step 2.4: Alternatives to Remodeling 24. The seller may then obtain a set of plans and an estimate for the remodel. Rather than carrying out the remodel, the seller may present the plans and estimate to the buyer and the buyer may decide whether to pursue the remodel. Similarly, if the counselor and/or online interactive tutorial 162 identifies style issues (i.e., worn or outdated cosmetics, paint, flooring, fixtures, window coverings, trim and appliances), the seller may be encouraged to make some of the small and inexpensive fixes. In one embodiment, the online interactive tutorial 162 may generate and provide a Style Issues Memorandum to seller device 110, that may offer different remedies for dealing with worn or outdated cosmetics. The memorandum may include suggestions such as: performing easy and inexpensive fixes, offering an allowance and offering a credit. In an example, a counselor may coach a seller to select the most effective remedy. Alternatively, the seller may be encouraged to offer an allowance to the buyer, or offer a credit to the buyer.

In Step 2.5: Deep Clean 25, the online interactive tutorial 162 may presents one or more checklists and guidelines to the seller that provide suggested guidance to the seller on cleaning of the real estate property. In some examples, an additional checklist may be presented in the event that one or more members of the seller's household is a smoker.

In Step 2.5: Complete Property Disclosures 26, the online interactive tutorial 162 may gather disclosure forms obtained from federal, state, and local government organizations, and the like. Once the disclosure forms are obtained, the online interactive tutorial 162 may present the forms to the seller for printing (and/or storage), and any signatures. The forms may disclose latent defects in the property, include well and septic inspection certificates, lead based paint disclosures, home inspection advisories and the like. In one embodiment, a counselor may be trained to assist the seller in completing the disclosure forms. In one embodiment, the information obtained from the seller may determine the forms the online interactive tutorial 162 presents to the seller for completion. For example, information regarding the age of the property, location of the property, etc. may determine whether a seller is provided with a lead paint certificate form and the like.

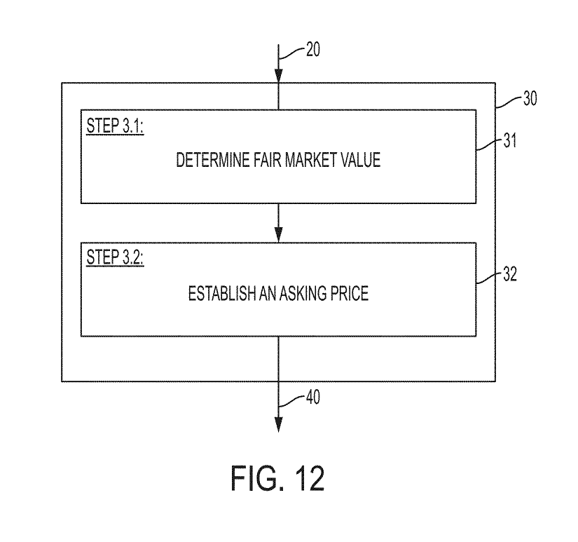

In one embodiment, after the completion of Step 2: Place a Property in Show Condition 20, the seller may proceed to the third step of the online interactive tutorial 162, namely, Step 3: Determine an Asking Price 30. As is illustrated by FIG. 12, an example process for Step 3: Determine an Asking Price 30, may include various sub-steps including for example, Step 3.1: Determine Fair Market Value 31, and Step 3.2: Establish an Asking Price 32. The main objective of Step 3 may be to determine an asking price at which the real estate property may be listed on MLS listings.

The online interactive tutorial 162 introduces an objective means of establishing an asking price. In the first step 3.1: Determine Fair Market Value 31, a counselor may provide the seller with an objective professional Comparative Market Analysis (CMA) of active listings and recent sales of properties that share one or more characteristics in common with the real estate property at issue. The counselor may prepare the CMA using a process that mirrors the buyer's process of using quantifiable search criteria in their on-line search for a home to buy. A counselor may use one or more home listing websites 120, via counselor device 1330, such as, MLS, Realtor.com, Zillow or Trulia to search for criteria related to home prices. In an example, a counselor may prepare two different CMAs, one based on pending and recently sold houses, and another for active listings. While sold houses are a good indicator of buyer demand, they may not reflect current market conditions. Active listings may be more relevant, because they represent the seller's competition. Search criteria may include one or more of number of bedrooms; number of bathrooms; number of garage spaces; house size, plus or minus 10%; lot size, plus or minus 20%; the year the home was built, plus or minus five years; or the neighborhood or school attendance area. Typically, for a normal house in a normal urban or suburban market, the search may find 10-12 comparable houses. A counselor may increase or decrease the number of comparable houses, based on factors related to a seller's house and comparable houses. The factors may include a recent remodel, the layout of the house (such as, ranch, two-story, etc.), the architectural style of the house, or special features (such as, waterfront, community association etc.) In some embodiments, the counselor may use these factors to identify three or four very close approximations of the seller's house.

A counselor may calculate the price per square foot of the best comparable properties found with the search. A counselor may multiply the price per square foot of the best comparable properties by the number of square feet in the seller's house, to produce a range of prices for the seller's house. Accordingly, in one embodiment, the CMA may provide a range of prices that are representative of the fair market value and are then presented by the counselor to the seller. In an embodiment, a counselor may present the CMA to a seller via seller device 110, using GUI 112 or web browser 114. In another embodiment, a counselor may present the CMA to a seller at a home visit and discuss it with them. In another embodiment, counselor may communicate the CMA to a seller via phone, Skype, social media, email, instant messaging, and the like.

As a part of Step 3.2: Establishing an Asking Price 32, the seller may make price adjustments to the CMA. In one embodiment, in order to ensure that the adjustments are calculated objectively, a seller may do the adjustment calculation in advance of seeing the CMA provided by the counselor. Prior to a counselor session or receiving the CMA via the seller device 110, the seller may use online interactive tutorial 162 to calculate price adjustments. Price adjustments may be calculated as positive or negative points, related to positive and negative market conditions. In an example, a seller may use one or more worksheets to calculate price adjustments while in a neutral environment, (i.e., without knowing what the CMA shows).

In one embodiment, a price may be adjusted upwards (a higher asking price) for stable and/or rising market dynamics, selling during spring and/or summer, when the show condition is high, when the seller is financing or is a lease purchase, for a selling goal of Top Dollar, when the housing market is appreciating at double digits, or the like. In one embodiment, a price may be adjusted downwards (a lower asking price) for falling or unstable market conditions, selling during the holidays, when tenants are present on the property, when the seller cannot hold regular open houses, for low show conditions, for a selling goal of Quick Sale or Emergency Sale, or when the seller is selling into a failing market. In one embodiment, the seller may enter their answers regarding questions based on the above market and property conditions such that the computational modules 165 of the server 160 may receive the answers and compute the appropriate price adjustment. The various algorithms or calculations including that for adjusting the CMA provided by the present systems and methods are discussed below.

After a seller has made price adjustments, the seller's adjusted weight, the CMA and the average price for the house from the CMA may be reviewed with the counselor. If there is an issue as to whether a house is a good comparable property, a seller may make an appointment to look at the comparable house, or attend a scheduled open house.

Optionally, Step 3.2: Establishing an Asking Price 32, may also include calculating a Baseline CMA. A Baseline CMA may be dependent upon the average price per square foot of the comparable properties (from the CMA) and is discussed in full, below, in relation to various algorithms or calculations determined by computational modules 165.

Optionally, Step 3.2: Establishing an Asking Price 32, may further include polishing (i.e., adjusting) the asking price. Polishing may include one or more sub-steps geared directly towards the search parameters a buyer typically enters into a home listing website to find houses that meet their criteria. Polishing may include matching search parameters. A buyer's search parameters are often expressed in $10,000 increments. For instance, if an asking price is $402,500, it will miss prospective buyers who cut off their search parameter at $400,000. Polishing may include matching search parameters by dropping an asking price below the next lowest natural cutoff used for searching. For instance, in the $402,500 situation, the asking price may be dropped to $399,000. Polishing may also include rounding up the price. Rounding up the price may include making an extra $900 by rounding up the asking price from the price determined by matching search parameters to the nearest $900. For example, in the case of a $399,000 asking price determined by dropping below the next lowest natural cutoff used for searching, the asking price may be rounded up to $399,900.

The determined asking price may be input to the dashboard 132 by a seller using seller device 110, or a counselor using counselor device 130. The determined asking price may be displayed on GUI 112, a flyer, an MLS listing and any marketing materials produced by the systems and methods described herein.

In some embodiments, Step 3: Determine Asking Price 30 may include special pricing situations, including, a short sale or a falling market. In such an embodiment, the GUI 112, and more specifically the interactive input area 411 of the online interactive tutorial 162 may include one or more additional links to select documentation related to special pricing situations. A first additional link may link to a short sale document related to a seller owing more on the house than it is worth (i.e., a short sale situation). A short sale document may advise the seller as to how to find the extra money to pay off their mortgage, to save their credit rating, and to prevent a delay (and consequent buyer uncertainty) inherent in a short sale process. However, if a short sale is the only option, the short sale document may advise contacting a lender to get a loan process going as soon as possible.

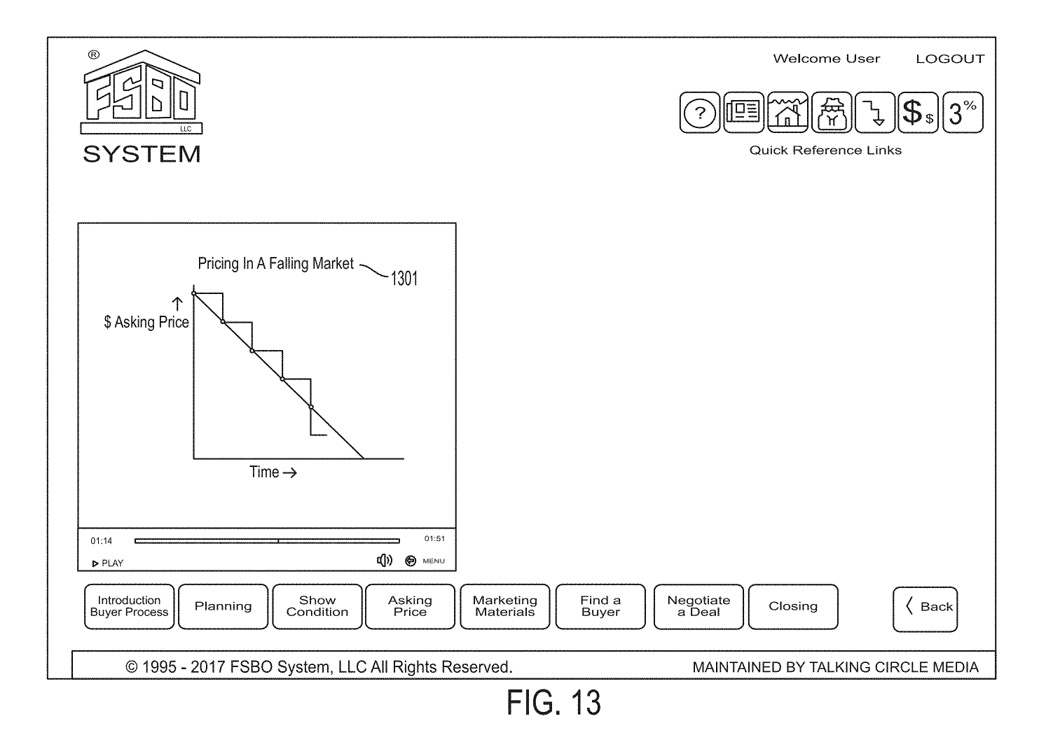

A second additional link may link to a falling market document. In a falling market, the longer the house is on the market, the lower the sale price, or, conversely, the quicker the sale, the higher the sale price. In a falling market, the goal may be simply for the seller to get a deal. In an example, a second additional link may link to one or more graphs showing a relationship between an initial asking price, price reductions, and time to sell. In another example, a second additional link may link to a video presentation related to falling market conditions, as illustrated in FIG. 13. In a further example, a second additional link may link to a combination of a video presentation related to falling market conditions and one or more graphs 1301 showing the relationship between an initial asking price, price reductions, and time to sell. GUI 112 may display one or more print buttons linked to print falling market documentation for adding to a Seller's Manual, via printing device 150 (or may include one or more buttons to electronically store the falling market documentation).

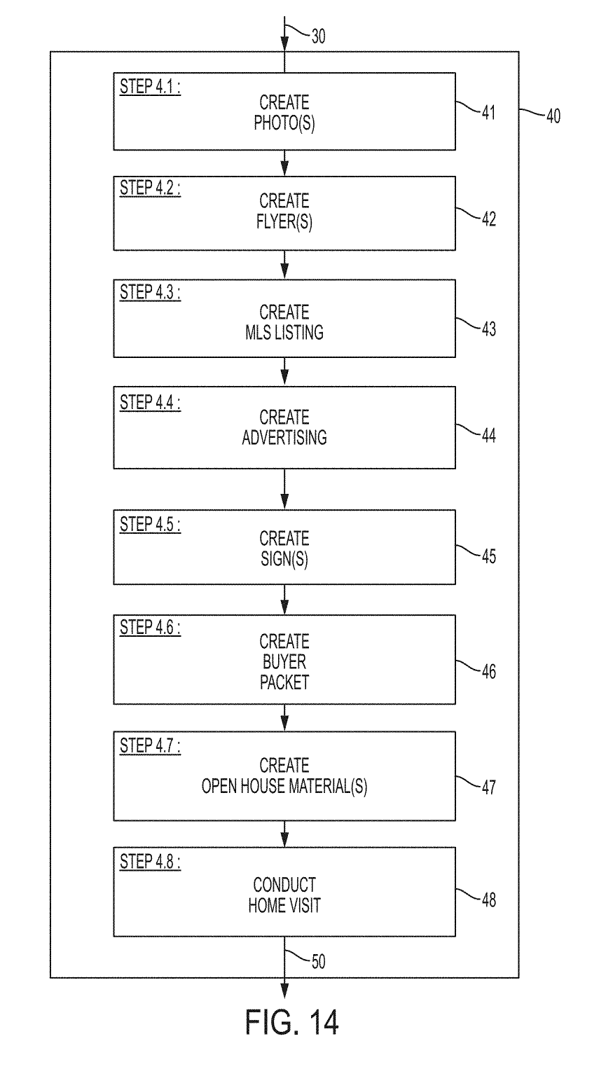

In one embodiment, after the completion of Step 3: Determining an Asking Price 30, the seller may proceed to the fourth step of the online interactive tutorial 162, namely, Step 4: Produce Marketing Materials 40. As is illustrated by FIG. 14, an example process for Step 4: Produce Marketing Materials 40, may include various sub-steps including for example, Step 4.1: Create Photo(s) 41, Step 4.2: Create Flyers 42, Step 4.3: Create MLS Listings 43, Step 4.4: Create Advertising 44, Step 4.5: Create Sign(s) 45, Step 4.6: Create Buyer Packet 46, Step 4.7: Create Open House Material(s) 47, and Step 4.8: Conduct Home Visit 48.

As a part of Step 4: Producing Marketing Materials 40, a seller may take (i.e., capture) and upload one or more pictures to the online interactive tutorial 162. The photos created in Step 4.1: Create Photo(s) 41 may include exterior photos and interior photos. In some examples, tutorial 162 may also support the capturing and uploading of videos. The online interactive tutorial 162 may provide instructions for taking the optimal quality of photographs and videos. In one embodiment, a seller may receive feedback on the quality of images uploaded to the online interactive tutorial 162 from the tutorial 162 and/or the counselor via the counselor device 130. The photos and videos may be used in all the prepared marketing materials and MLS listing.

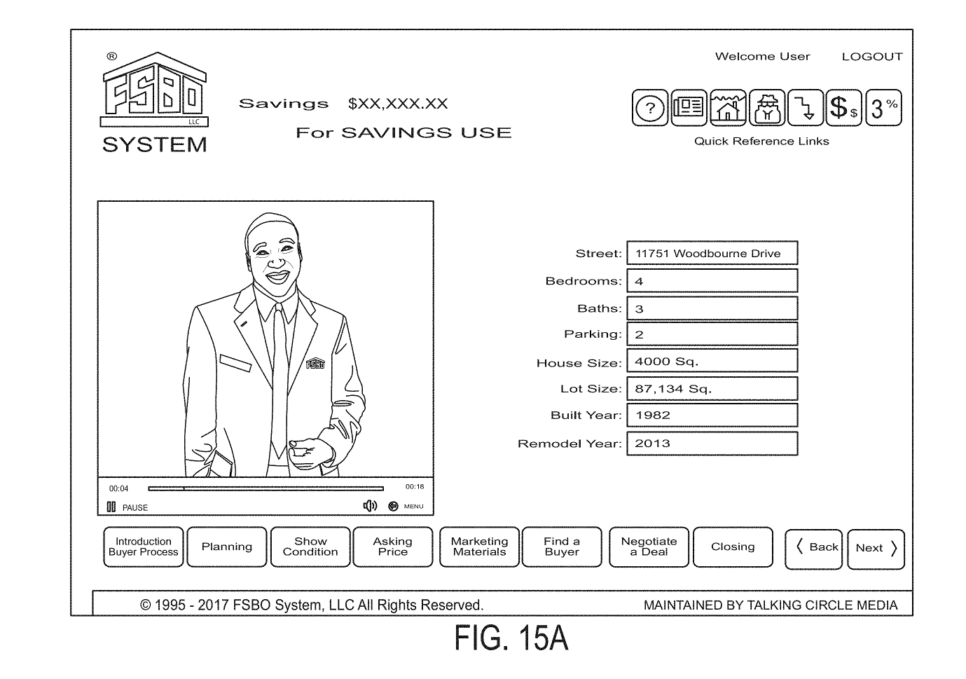

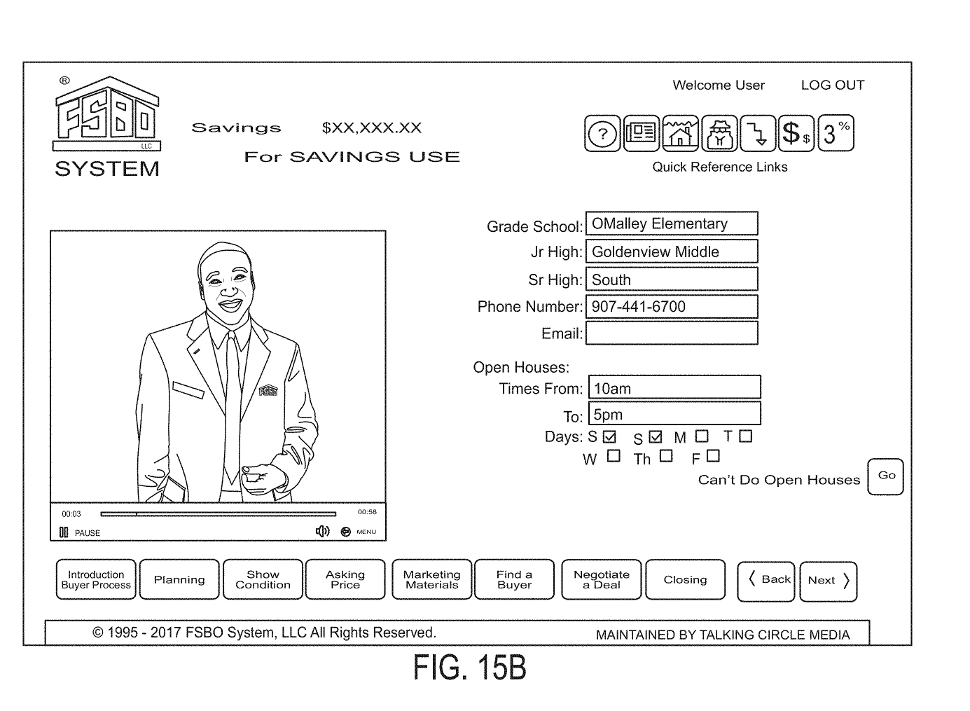

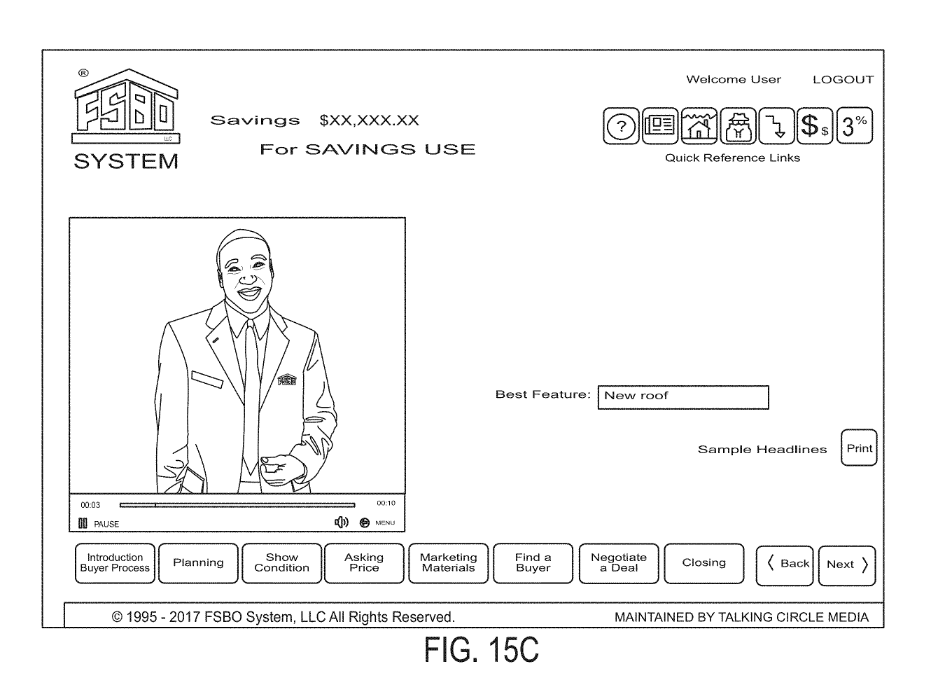

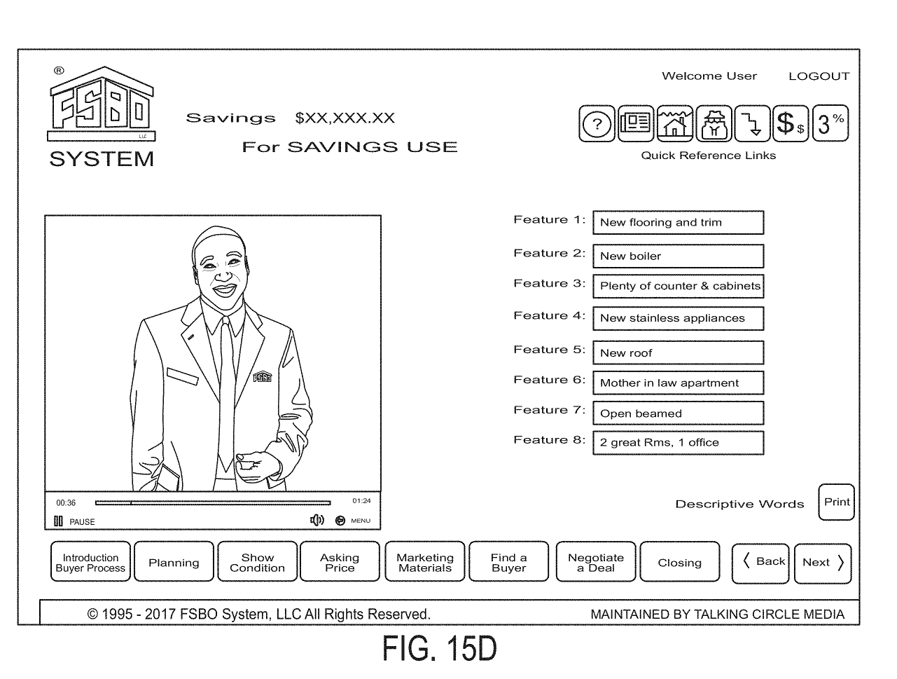

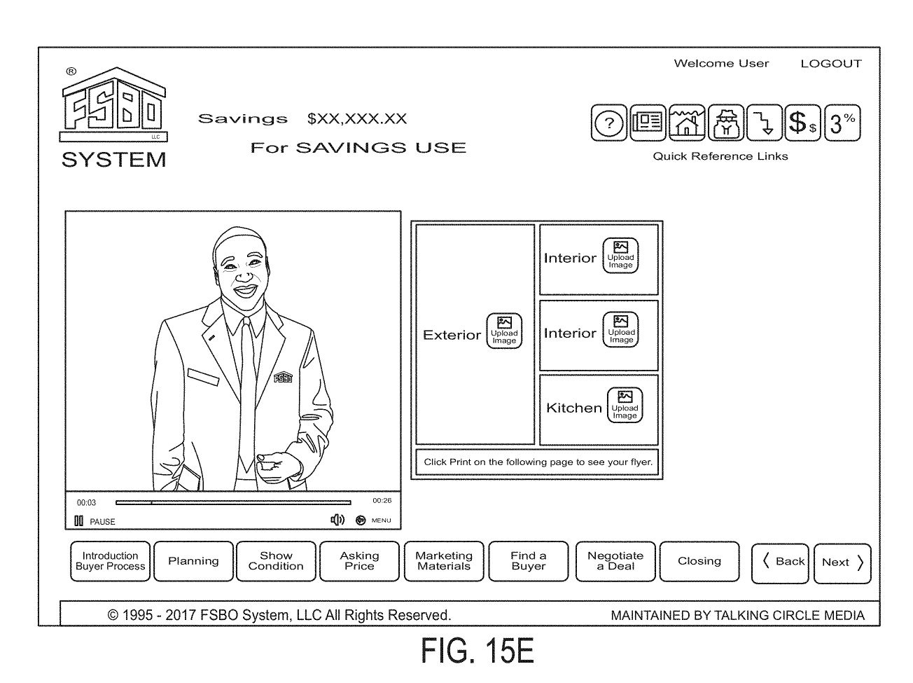

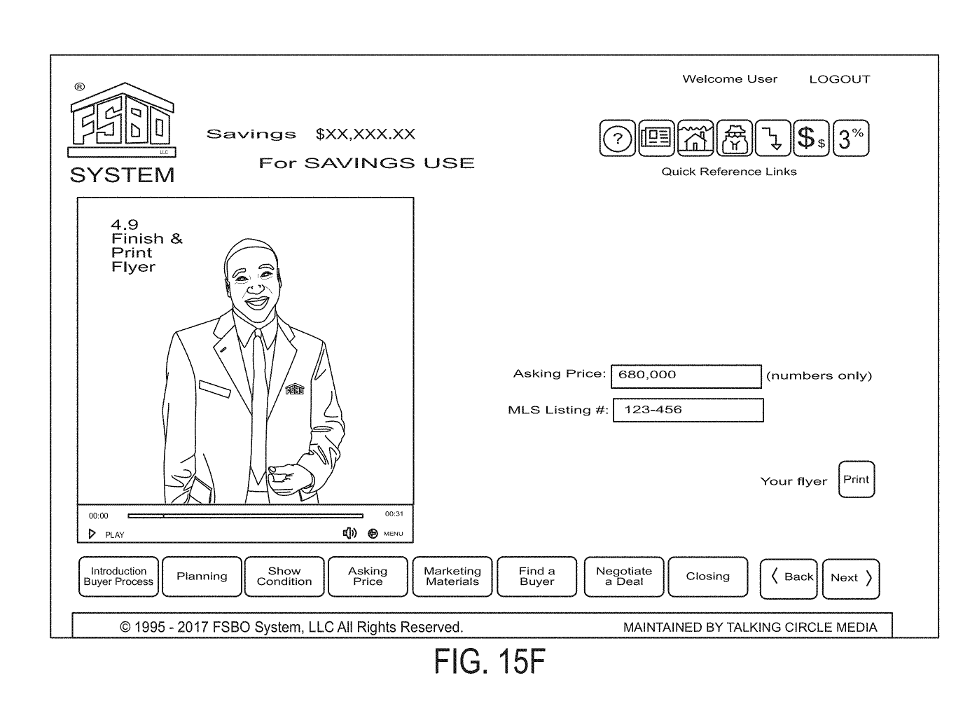

As a part of Step 4.2: Create Flyer(s) 42, the seller may enter information into one or more fields of the interactive input area 411 of the online interactive tutorial 162, as is illustrated in FIG. 15A. For example, the seller may input data and information related to the address, number of bedrooms, number of bathrooms, parking, house size, lot size, year built, and year remodeled. Once a first set of information is entered and transmitted to the server 160, a second set of information may be requested from the seller, as is depicted in FIG. 15B. For example, as depicted in FIG. 15B, the interactive input area 411 may request information related to nearby schools, contact information for the seller, and times for regularly scheduled open houses. By holding regular open houses, the need for a buyer's agent may be eliminated. Additionally, the interactive input area 411 may request information related to the best feature of the property, as illustrated in FIG. 15C, and other features of the property (optionally, those not visible from the front of the house) as illustrated in FIG. 15D. The seller may then upload one or more photos and videos taken during Step 4.1: Create Photo(s) 41 to the interactive input area 411 as is illustrated in FIG. 15E. The photos may include exterior and interior photos, including the kitchen.

Additionally the seller may input the asking price (see Step 3: Determining an Asking Price discussed above) and MLS information as is illustrated in FIG. 15F. The data and information input into the interactive input area 411 may then be transmitted to the server 160, and server 160 may then create a sample flyer. The sample flyer may then be transmitted back to the seller, and printed at the seller's printing device 150 (or another printing device). The flyer constructed in this process may be transmitted and stored on the CSU 160 for use by the counselor. Any updates to the flyer by the seller using the online interactive tutorial 162 may also be transmitted and stored on the CSU 164 and provided to the counselor. In one embodiment, the CSU 164 may detect that a flyer has been completed and transmit a notification (i.e., email) to the counselor device indicating the flyer has been created It is noted that the systems and methods described herein often utilize open houses to attract buyers of the real estate property. Accordingly, in one embodiment, the flyer may reflect regular, scheduled, advertised open houses for the real estate property. Thus the systems and methods described herein allow for real estate transactions to proceed without the presence of an agent.

As a part of Step 4.3: Create A MLS Listing 43, the online interactive tutorial 162 may provide the seller with MLS input forms and checklists. The data and information input via seller device 110 for the flyer (including photos) may be used to complete the MLS input form. In one embodiment, online interactive tutorial 162 may gather information from the seller via the seller device 110, construct an electronic version of the MLS input form at the server 160, and submit the created MLS form to one or more home listing websites 120.

As a part of Step 4.4: Create Advertising 44, the online interactive tutorial 162 may include guidance on how the seller may advertise on different platforms including social media. In one embodiment, the online interactive tutorial 162 may include links to and may be integrated with social media websites that allow the seller to upload their created flyer. In one embodiment the uploaded flyer information may be stored in the database 170.

As a part of Step 4.5: Create Sign(s) 45, the online interactive tutorial 162 may provide the seller with an electronic version of a sign that may be printed at a local office store and the like. Alternatively, the counselor may print the signs and provide them to the seller. Like the flyer(s) created in Step 4.2, the signs may also be based on the seller's responses to prompts in the interactive input area 411 of the online interactive tutorial 162.

As a part of Step 4.6: Create Buyer Packet 46, the online interactive tutorial 162 may include links to a purchase and sales agreement that may be a part of the buyer packet. In one embodiment the purchase and sales agreement may be drafted in plain English (i.e., in layman's terms). In one embodiment, the purchase and sales agreement may be capable of electronic signature. Optionally, in one embodiment, the purchase and sales agreement may be capable of electronic execution. In an alternative embodiment, the purchase and sales agreement may be reviewed, and then printed and/or copied. The purchase and sales agreement may be filled in by the seller and/or buyer with assistance from the online interactive tutorial 162 and/or a counselor.

As a part of Step 4.7: Create Open House Material(s) 47, the online interactive tutorial 162 may provide the seller with a telephone log and guest log so that seller may track visitors to an open house for the real estate property. Additionally, the online interactive tutorial 162 may provide advice to the seller for conducting a real estate transaction with and without buyer's agents. The online interactive tutorial 162 may provide the seller with one or more signs that may be displayed by the seller during the open house so that a buyer may take a self-conducted tour of the real estate property. In one embodiment, the signs may correspond to the features entered by the seller into the interactive input area 411 as a part of Step 4.1. The signs may be provided in an electronic format that is transmitted to the seller device 110 and printed by one or more printing devices 150. In one embodiment, the seller may compile all of the documents provided by the online interactive tutorial 162 in a central location (either electronically or physically).

As a part of Step 4.8: Conduct Home Visit 48, the seller may be visited by a counselor prior to an open house. After the seller has placed the real estate property in “show condition” the seller may indicate via the online interactive tutorial 162 that the property, disclosures, and prepared materials are ready for review by a counselor (e.g., are ready to go on the market). Upon receiving an indication, the CSU may 164 transmit a notification to the counselor device 130 and counselor so that the counselor schedules a visit with the seller. In one embodiment, a calendar and appointment system on the sever 160 may facilitate scheduling a meeting between the seller and counselor.

Prior to the home visit, the counselor may conduct a comparative market analysis (CMA) as described in Step 3.1. In some embodiments, the CMA may require utilizing one or more computational modules 165 of the server system 160. At the home visit the CMA may independently score the show condition of the house, review the property disclosures, review the marketing materials, review the seller's price adjustments, and deliver various marketing materials (e.g., signs developed in Step 4.2).

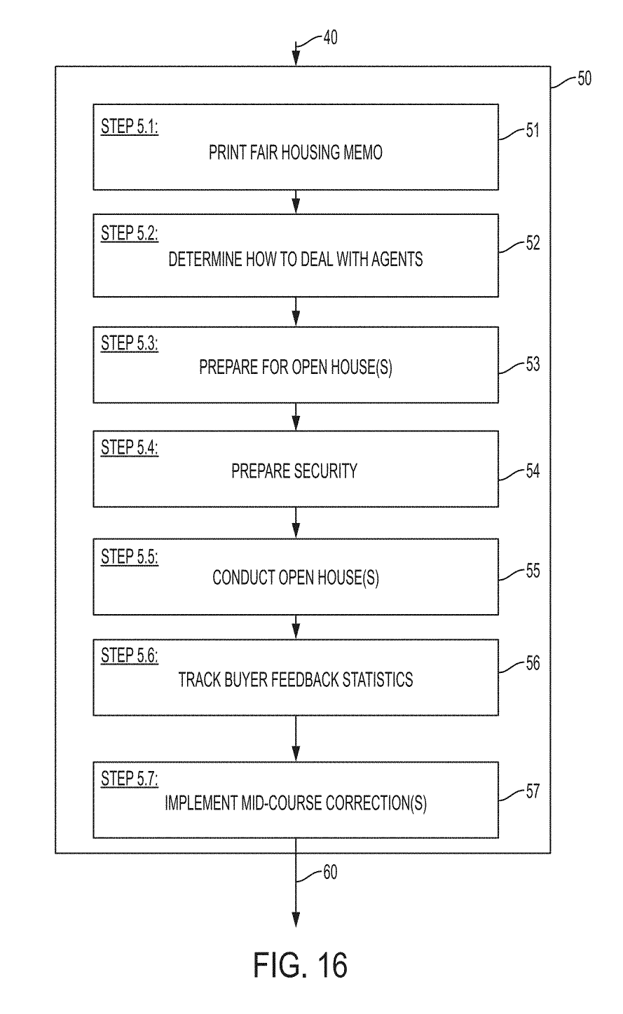

In one embodiment, after the completion of Step 4: Produce Marketing Materials 40, the seller may proceed to the fifth step of the online interactive tutorial 162, namely, Step 5: Find a Buyer 50. As is illustrated by FIG. 16, an example process for Step 5: Find a Buyer 50, may include various sub-steps including for example, Step 5.1: Print Fair Housing Memo 51, Step 5.2: Determine How to Deal With Agents 52, Step 5.3: Prepare for Open House(s) 53, Step 5.4: Prepare Security 54, Step 5.5: Conduct Open House(s) 55, Step 5.6: Track Buyer Feedback Statistics 56, and Step 5.7: Implement Mid-course Correction(s) 57.

As a part of Step 5.1: Print Fair Housing Memo 51, the online interactive tutorial 162 may provide anti-discrimination training to the seller by way of the tutorial 162 and/or the counselor. Anti-discrimination training may include electronic documentation, video, audio and the like.

As a part of Step 5.2: Determine How to Deal with Agents 52, the online interactive tutorial 162 may provide the seller with guidance as to how address buyers who wish to pursue a real estate transaction using a buyer's agent. Guidance may include electronic documentation, video, audio and the like. In some embodiments, a seller may be able to complete the real estate transaction without having to pay a commission to the buyer's agent or may remove the role of the buyer's agent.

As a part of Step 5.3: Prepare for Open House(s) 53, the seller may, for example, distribute the flyers and signs created in Step 4: Produce Marketing Materials 40 about one or more neighborhoods. Additionally, the seller may be guided (via electronic documentation, video, audio and the like) to distribute marketing materials prior to each open house.

As a part of Step 5.4: Prepare Security 54, the seller may be guided (via electronic documentation, video, audio and the like) by the online interactive tutorial 162 to remove valuables from the property. The seller may also be provided with guidelines for personal security.

As a part of Step 5.5: Conduct Open House(s) 55, the seller may hold an open house. Prior to holding an open house, the seller may review one or more instructional videos from the online interactive tutorial 162 for suggestions on how to hold an open house.

As a part of Step 5.6: Track Buyer Feedback Statistics 56, the seller may input one or more metrics representative of the effectiveness of the open house into the online interactive tutorial 162. In particular, the seller may provide the online interactive tutorial 162 with a measure of flyer loss (which may be indicative of how many people were aware of the open house), a visitor ratio (which is the number of new visitors to the open house), and a return visitor ratio (which is the number of return visitors to the open house). In one embodiment, upon receiving these values by way of the online interactive tutorial 162, the computational modules 165 may compute a ratio of the visitors to flyer loss and/or a ratio of the return visits to initial visits. Alternatively, the seller may calculate the ratios and provide them to the online interactive tutorial 162.

Based on the statistics and metrics entered in Step 5.6: Track Buyer Feedback Statistics 56, in Step 5.7: Implement Mid-Course Correction(s) 57, the seller may make one or more mid-course corrections. For example, when the measured flyer loss is below a certain threshold, this value may be an indication of a problem in the advertising strategy (i.e., MLS listing, display of signs, frequency of open houses). In one embodiment, the threshold may depend on the season (i.e., spring and summer may include a higher flyer loss). Accordingly, the seller may adapt their advertising strategy with guidance from the online interactive tutorial 162 and/or the counselor. Additionally, when the visitor ratio is determined to be low (i.e., below a threshold), this value may be indicative that the seller's asking price is not viable (too high). When the visitor ratio is determined to be too high (i.e., above a threshold), this value may be indicative that the seller's asking price is also not viable (too low). The return ratio may be indicative of whether the buyers like the real estate property. When the return ratio is low (i.e., below a threshold), this value may be indicative of a problem with the show condition, functional issues with the house, style issues, and/or problems with the buyer's experience. The counselor and/or interactive online tutorial 162 may provide the seller with possible mid-course correction suggestions such as advertising differently, reducing the price of the real estate property, adjusting the show condition, refraining from interacting with potential buyers at the open house, and the like.

In one embodiment, if the seller elects to reduce the price of the listing as a part of the mid-course correction, the online interactive tutorial 162 may prepare updated flyers, signs, and the like for use by the seller. Additionally the online interactive tutorial 162 may assist the seller in updating the MLS listing for the house with the new price. The seller may be encouraged to contact previous visitors to the real estate property (as logged by the telephone and guest log) to notify them of the new price.

In one embodiment, various mid-course corrections may be determined based on statistics performed by the buyer-focused computational utility 168. Mid-course corrections may include, for example: suggestions for more frequent open houses, obtaining renovation plans (but not performing the renovations), cleaning more items out of the house or garage, more self-guided tour signage, offering a commission (e.g., 3%) to buyer's agents and/or price reduction. A price reduction may include: suggestions for discussing (e.g., via email, phone, physical discussion, etc.) the reduction with a counselor (to identify whether price is the issue), selecting a new price, contacting (e.g., emailing) a counselor with the new price, suggestions on how to indicate the reduction (e.g., using a black marker to cross through the price on a flyer so it can still be seen, writing across a photo on the flyer “REDUCED!!!” and the new price, and calling visitors on a guest log and telephone log and inviting them back).

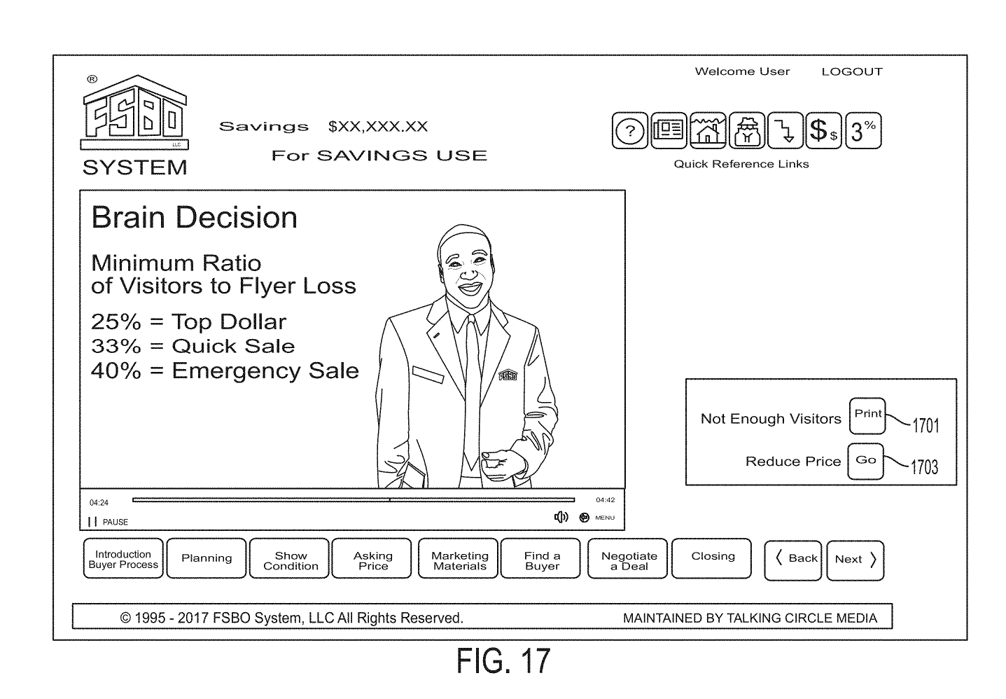

FIG. 17 is illustrative of the options the online interactive tutorial 162 may present to a seller when making mid-course corrections. As depicted, the seller may indicate that there were not enough visitors at a first selector 1701 and receive additional guidance from the online interactive tutorial 162. Alternatively the seller may opt to reduce the price of the listing at a second selector 1703.

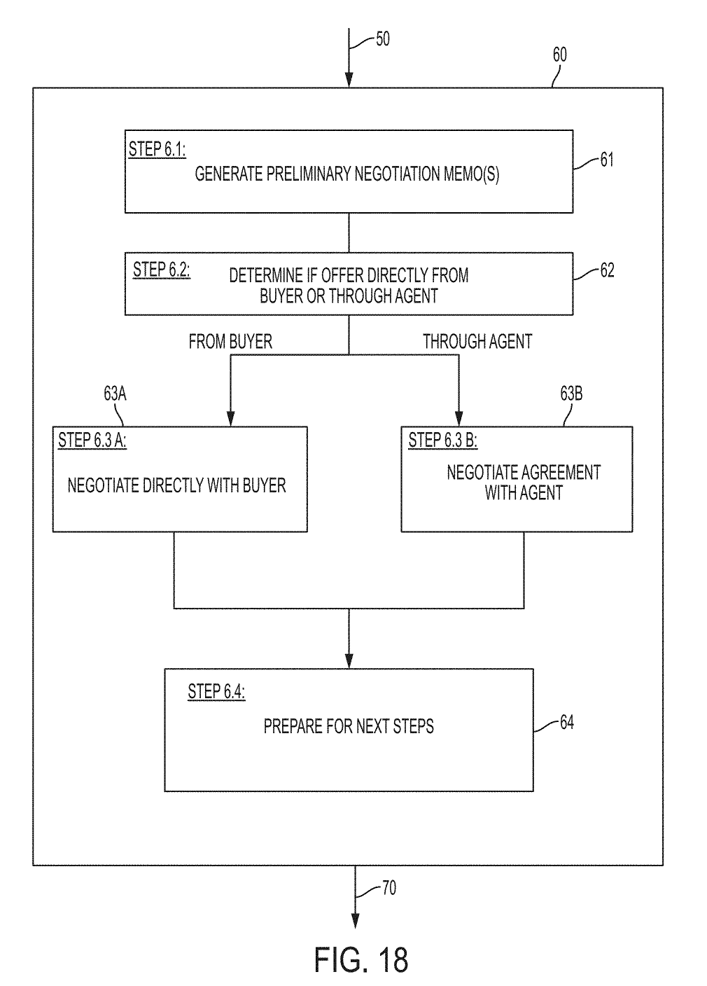

In one embodiment, after the completion of Step 5: Find a Buyer 50, the seller may proceed to the sixth step of the online interactive tutorial 162, namely, Step 6: Negotiate a Real Estate Transaction 60. As is illustrated by FIG. 18, an example process for Step 6: Negotiate a Real Estate Transaction 60, may include various sub-steps including for example, Step 6.1: Generate Preliminary Negotiation Memo(s) 61, Step 6.2: Determine if an Offer is Directly from a Buyer or Through a Buyer's Agent 62, Step 6.3A: Negotiate Directly with Buyer 63A (when the offer is directly from a Buyer), Step 6.3B: Negotiate Agreement With Agent 63B (when the offer is through an Agent), and Step 6.4: Prepare for Next Steps 64. In a first step 6.1: Generate Preliminary Negotiation Memo(s) 61, the online interactive tutorial 162 and counselor may provide the seller with information regarding the negotiation process, and tips, including those useful for when negotiating with multiple buyers.

In a second step 6.2: Determine if an Offer is from a Buyer or a Buyer's Agent 62. In this step, the seller may determine whether the received offer is from a buyer or their representative. In one embodiment, the seller may provide the tutorial 162 with a selection as to whether the received offer is from a buyer or their representative.

When the received offer is from a buyer, then in Step 6.3A the seller may negotiate directly with the buyer 63A. As a part of the negotiation process, the seller may prepare (for example, with the online interactive tutorial 162 and/or counselor) a buyer's packet containing one or more documents including property disclosure documents, and purchase and sale agreement documents (see also Step 4.6). Additionally, the buyer's packet may include one or more addendums such as, without being limited to, a repair addendum, early occupancy, holdover tenancy, prior sale, Federal Housing Administration (“FHA”) or Department of Veterans Affairs (“VA”) loan information, owner financing terms, and off-market agreements.

In general, the counselor may assist the seller during the negotation process. In one embodiment, the counselor may assist during the negotiation process through the online interactive tutorial 162. For example, the counselor may answer questions via phone, email, text, instant messaging, or other communication platform provided by the online interactive tutorial.

When the received offer is through an agent, then in Step 6.3B the seller may negotiate with the buyer's agent 63B (instead of directly with the buyer). The online interactive tutorial 162 may provide behavioral guidance (e.g., electronic documentation, video, audio and the like) to the seller so that they are not pressured into paying a commission fee to the buyer's agent. If however, the seller elects to pay a fee to the buyer's agent (as may be the case for Emergency Sales), the online interactive tutorial 162 may provide the seller with a Single Party Commission Agreement.

In one embodiment, Step 6.3 may include calculating a Buyer's Agent commission when there is a buyer's agent involved. For example, mid-course correction suggestions may include convincing the agent to reduce their 3% commission by 0.5%, to 2.5%; a buyer paying 1.2% of that amount to their agent in the form of a higher price for a real estate property; and a seller paying the balance, 1.3%. In an example, a recalculated Seller's Savings may be determined by a sale price—any commission paid.

In Step 6.4: Prepare for Next Steps 64 the seller may be advised by the online interactive tutorial 162 to make copies of the purchase and sales agreement, as well as execute the purchase and sales agreement. Additionally, the online interactive tutorial 162 may include a calculator on GUI 112 to enter the sale price and (optionally) any commission paid to a buyer's agent, so that the seller's actual savings may be calculated by the computational modules 165. The online interactive tutorial 162 may also include a calculator for performing one or more mathematical operations. Additionally, the online interactive tutorial 162 may include a process for opening escrow at an escrow closing company. The tutorial may also encourage a seller to upload a photograph of the seller and/or buyer in front of the sold real estate property holding a SOLD sign. The CSU 164 may receive the data and information uploaded by the seller (including, for example the selling price, escrow information, days on market, and photo), identify the relevant data from tutorial 162, cause computational modules 165 to calculate the savings from this information, and transmit the information to counselor device 130. The counselor may then facilitate any paperwork surrounding the pending MLS listing and opening escrow responsive to the information received from CSU 164.

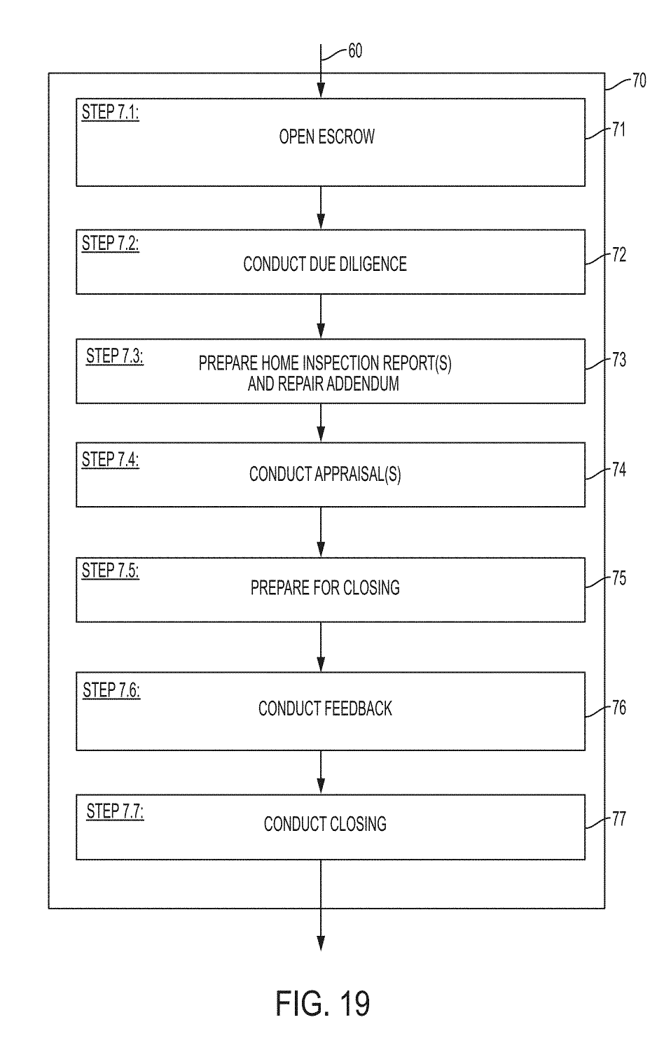

In one embodiment, after the completion of Step 6: Negotiate a Real Estate Transaction 60, the seller may proceed to the seventh step of the online interactive tutorial 162, namely, Step 7: Close the Real Estate Transaction 70. As is illustrated by FIG. 19, an example process for Step 7: Close the Real Estate Transaction 70, may include various sub-steps including for example,

Step 7.1: Open Escrow 71, Step 7.2: Conduct Due Diligence 72, Step 7.3: Prepare Home Inspection Report(s) and Repair Addendum 73, Step 7.4: Conduct Appraisal(s) 74, Step 7.5: Prepare for Closing 75, Step 7.6: Conduct Feedback 76 and Step 7.7: Conduct Closing 77. In one embodiment, the seller may be in daily contact with the buyer throughout Step 7: Close the Real Estate Transaction 70.

In Step 7.1 Open Escrow 71, the online interactive tutorial 162 may provide a seller with guidance (e.g., video, audio, electronic documentation, etc.) as to opening an escrow account including information regarding the process, the documents required and the like. For example, the online interactive tutorial 162 may instruct the seller to obtain a Preliminary Commitment for Title Insurance. The online interactive tutorial 162 may also generate a calculator and/or other means that may be made available to the seller, to determine whether the real estate transaction may result in a short sale for the seller. In order to determine whether the real estate transaction may result in a short sale, in one embodiment, the seller may input the firm sale price and details of existing mortgages, liens, and the like into the online interactive tutorial 162. The online interactive tutorial 162 may then transmit the data and information to the computational modules 165, which may make a determination as to whether the real estate transaction may result in a short sale. When a determination is made that the real estate transaction may result in a short sale, the online interactive tutorial 162 may update with documents, video tutorials, and other resources for the seller related to short sale guidance.

In Step 7.2 Conduct Due Diligence 72, the online interactive tutorial 162 may guide a seller through providing data and information to a buyer. For example, the seller may prepare and provide the seller with information such as, without being limited to, a resale certificate, an as-built survey, well and septic information, a lead-based paint certificate, sex offender registry information, an annual property operating data form, and any amendments to the property disclosure form. In one embodiment, the online interactive tutorial 162 may link to one or more legal statutes, that may provide more information regarding the data and information the seller may be legally obligated to prepare and provide to a buyer.

In connection with Step 7.3 Prepare Home Inspection Report(s) and Repair Addendum 73, a buyer may perform a home inspection (optional) and request one or more of the recommended repairs be completed by the seller. The online interactive tutorial 162 and counselor may guide a seller through the home inspection process, and the list of recommended repairs.

In Step 7.4 Conduct Appraisal(s) 74 the online interactive tutorial 162 may provide instructions as to interactions between the seller and buyer and/or appraiser during the appraisal process. For example, when the CMA prepared by the counselor supports the sale price, the seller may be encouraged to provide the CMA to the appraiser. In one embodiment, the online interactive tutorial 162 may support electronically transmitting the CMA from the online interactive tutorial 162 to the appraiser via email or other means, upon the server system 160 receiving a request from the seller. Additionally, if the buyer is using Federal Housing Administration (“FHA”) or Veterans Administration (“VA”) loans, the online interactive tutorial 162 may guide the seller through one or more forms for FHA and VA loans including, for example, a FHA/VA Amendatory Clause.

In Step 7.5: Prepare for Closing 75, the online interactive tutorial 162 and/or counselor may guide the seller through the closing. In one embodiment the online interactive tutorial 162 may provide the seller with a moving checklist and an address change checklist. Optionally, the online interactive tutorial 162 may electronically interface with an escrow closing company to transmit and receive the relevant closing documents and power of attorney. Additionally when it is determined that the real estate transaction may not close in a timely manner, the online interactive tutorial 162 may provide the seller with an Extension Agreement that both the buyer and seller may complete to extend the time of the real estate transaction. In one embodiment, the online interactive tutorial 162 may facilitate the Extension Agreement by transmitting the Extension Agreement electronically to the buyer and/or seller device and being configured for online signatures.

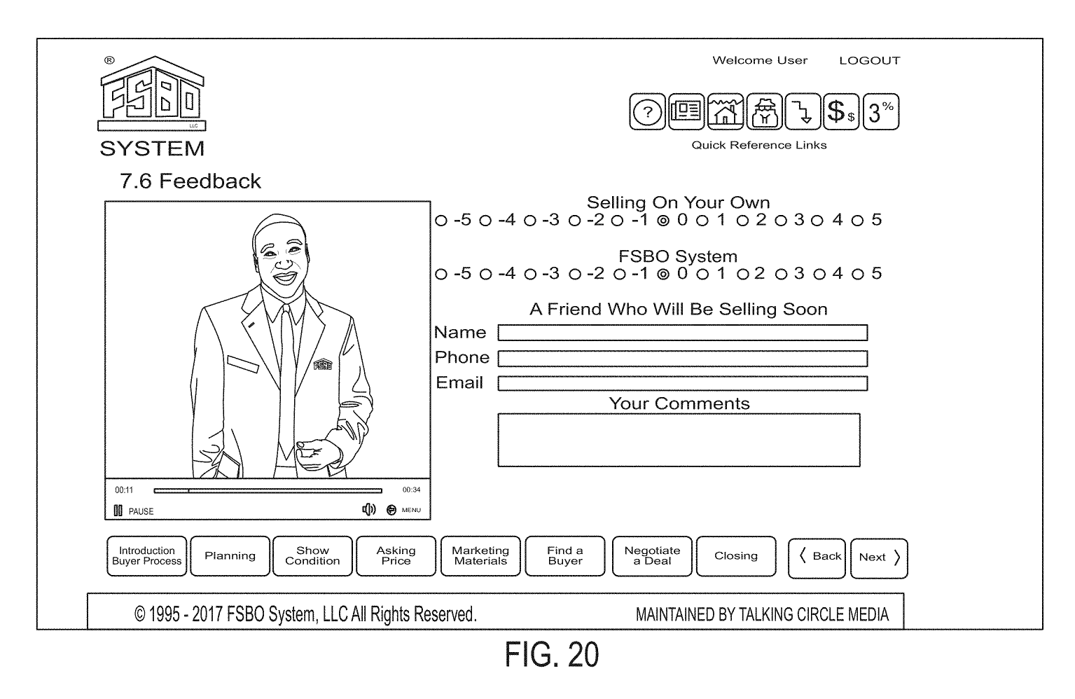

In Step 7.6: Conduct Feedback 76, the online interactive tutorial 162 may request that a seller provide information related to their experience. In one embodiment, feedback may include rating one or more features of the online interactive tutorial 162, and counselor. In one embodiment, the feedback may be used to calculate statistics related to the online interactive tutorial 162 and counselor's performance. Additionally, the online interactive tutorial 162 may be improved in accordance with the received feedback. The feedback may be transmitted to the counselor and/or stored in the database of the server system 160. Feedback may be entered via the tutorial 162 as is illustrated in FIG. 20.

In Step 7.7: Conduct Closing 77, the real estate transaction is finalized. The online interactive tutorial 162 may provide the seller with a checklist of items to bring including, for example, photo identification, keys, mailbox keys, garage door openers, signs, brochures, bank account information, routing information and the like. In one embodiment, the closing is attended by the counselor, buyer, seller, and/or agent(s) (e.g., a buyer's agent). Prior to the closing, the counselor may check the deed, check the settlement statement, verify that the closing costs are apportioned according to the purchase and sales agreement, and close out the listing on the MLS system. In some examples, tutorial 162 and/or the counselor may indicate any submission date requirements for settlement documentation prior to and/or at the closing, in accordance with any local, state or federal regulations. Typically, on the next business day after the closing, the escrow closer may record the deed, and buyer's mortgage. The escrow closer may write a check to pay off all the seller's liens, mortgages, judgments, etc. and may write a check to the seller for the balance. If the buyer and seller have agreed to seller financing, the escrow closer may set up a payment escrow at a local bank. In one embodiment, the online interactive tutorial 162 may provide the seller with an overview information of what to expect at a closing.

Optionally, after the closing, the seller may enter data and information related to the closing and/or life after the real estate transaction into the online interactive tutorial 162. For example, in one embodiment, the online interactive tutorial 162 may provide the seller with a field or similar graphical user interface to feature so that the seller may enter information related to what they did with the savings afforded by system 100.

As discussed above, the data and information provided to the online interactive tutorial 162 by a seller using a seller device 110 may be routed to the customer service utility (CSU) 164, computational modules 165, database 170 and other components of the server 160. In one embodiment the computational modules 165 may include two or more separate computational utilities including a seller focused computational utility 166 and a buyer focused computational utility 168. In one embodiment, the computational utilities may form a single computational utility.

As discussed above the computational modules 165 may perform various algorithms or calculations based on the data and information server 160 receives from seller device 110, home-listing website(s) 120, counselor device 130, and/or optional buyer device 180.

In one embodiment, the computational modules 165 may perform seller focused calculations by way of the seller focused computational utility 166.

For example, the seller focused computational utility 166 may calculate a compensation (e.g., what the seller paid for the systems and methods described herein). For example, a compensation may equal one percent of the tax assessed value of the property.

In one embodiment, the seller focused computational utility 166 may calculate a seller's savings. For example, a seller's savings may be calculated as: seller's savings=a seller's ballpark price for the home—6% agent commission—what the seller paid for the system.

In one embodiment, the seller focused computational utility 166 may calculate a target closing date based on data and information received from the seller device 110 including, for example, a target sale date. For example, a target closing date may be calculated as: target closing date=target sale date+45 days.

In one embodiment, the seller focused computational utility 166 may calculate a target on market date based on data and information received from the seller device 110 including, for example, the seller's goals. For example, a target on market date may be calculated as: target on market date=target sale date+0-30 days for an emergency sale.

In one embodiment, the seller focused computational utility 166 may calculate a target closing date based on data and information received from the seller device 110 including, for example, the seller's goal. For example, a target closing date may be calculated as: target closing date=target sale date+30-60 days for a quick sale. Alternatively, a target closing date may be calculated as: target closing date=target sale date+>60 days for a top dollar sale option.

In one embodiment, the seller focused computational utility 166 may calculate a show condition score based on input received from the seller device 110. For example, a seller may check one or more checkboxes corresponding to the show condition of the house. The computational utility 166 may award points based on the checkboxes, and calculate a show condition score by adding the awarded points.

In one embodiment, the seller focused computational utility 166 may calculate a CMA and/or an adjusted CMA. The adjusted CMA may be calculated in a multi-step process. In a first step, a first factor may be calculated by subtracting points for various general market dynamics and conditions as discussed above in connection with Step 3.2 Establish an Asking Price 32. In an example, general market dynamics may include subtracting one or two points for falling market prices. In an example, points that may be subtracted for conditions may include: one point for selling during the holidays; one or two points for having tenants in the property; two points for not doing open houses on a regularly scheduled basis; one point for a show condition score of 4-6; two points when show condition is less than 4; one or two points for a selling goal of Quick Sale; five points when the selling goal is an Emergency Sale and up to five points when the seller is selling into a falling market.

In a second step, a second factor may be calculated by adding points for various conditions as is also discussed in relation to Step 3.2 Establish an Asking Price 32. In an example, the points that may be added may include: one point for selling during spring or summer; one point when the show condition score is 8 or 9; two points for show condition score of 10; one for seller financing or a lease purchase; one or two for a selling goal of top dollar and two when the housing market is appreciating at double digits. In an example, one or two points may be added for a general market dynamic of rising prices.

In a third step, a third factor, the Price Adjustment Weight, may be calculated based on the first and second steps. For example, the Price Adjustment Weight=Total Points from First Factor (i.e., minus points)+Total Points from Second Factor (i.e., positive points)+general housing market conditions+100 points.

In one embodiment, the seller focused computational utility 166 may also calculate the baseline CMA. For example, the Baseline CMA=Average price per square foot from Comparative Market Analysis X square footage of house being sold.

In one embodiment, the Adjusted CMA (also referred to as Asking Price) may be calculated using the Baseline CMA and the Price Adjustment Weight. For example, the Adjusted CMA=Baseline CMA X Price Adjustment Weight.

In one embodiment, the seller focused computational utility 166 may calculate the days on market based on information provided by the seller device 110 to the tutorial 162.

In one embodiment, a buyer focused computational utility 168 may be configured to perform various mid-course corrections, based on statistical computations of what prospective buyers actually do during a seller's marketing process. In one embodiment, the buyer focused computational utility 168 may calculate a number of statistics based on data and information received from the seller device 110. As discussed above, in one embodiment the seller enters information related to flyer loss (FL), visitors (V) and return visitors (RV) into the online interactive tutorial 162. The online interactive tutorial 162 may then route the received data and information to the buyer focused computational utility 168. In one embodiment, the buyer focused computational utility 168 is used in connection with Step 5.6: Track Buyer Feedback Statistics 56, discussed above.

The Flyer loss (FL) may represent the number of flyers taken from a brochure box. The Visitors (V) may represent the number of visitors signed into a Guest Log during an open house for the previous week. The Return Visitors may represent the number of visitors who kept an appointment to revisit the property.

In one embodiment, the buyer focused computational utility 168 may calculate, the Flyer loss, the Viability of Asking Price Ratio=V/FL, and the Show Condition Ratio=RV/V.

One or more of the embodiments discussed above may include a calculator in the interactive area 411. In one embodiment, the computations performed by the calculator may be integrated with the computational modules 165.

As discussed above, the online interactive tutorial 162 may receive data and information from the seller device 110, the home-listing website 120, and the like. In one embodiment the CSU 164 may be configured to receive data and information from the seller device 110 and, optionally, home-listing website 120 related to the real estate property the seller wishes to transact in. The CSU 164 may process the received data and information and provide the processed data and information to one or more web pages (described herein as a dashboard) configured for display to a counselor via GUI 132 of counselor device 130 (via web browser 134). Processing may include performing computations by the computational modules 165.

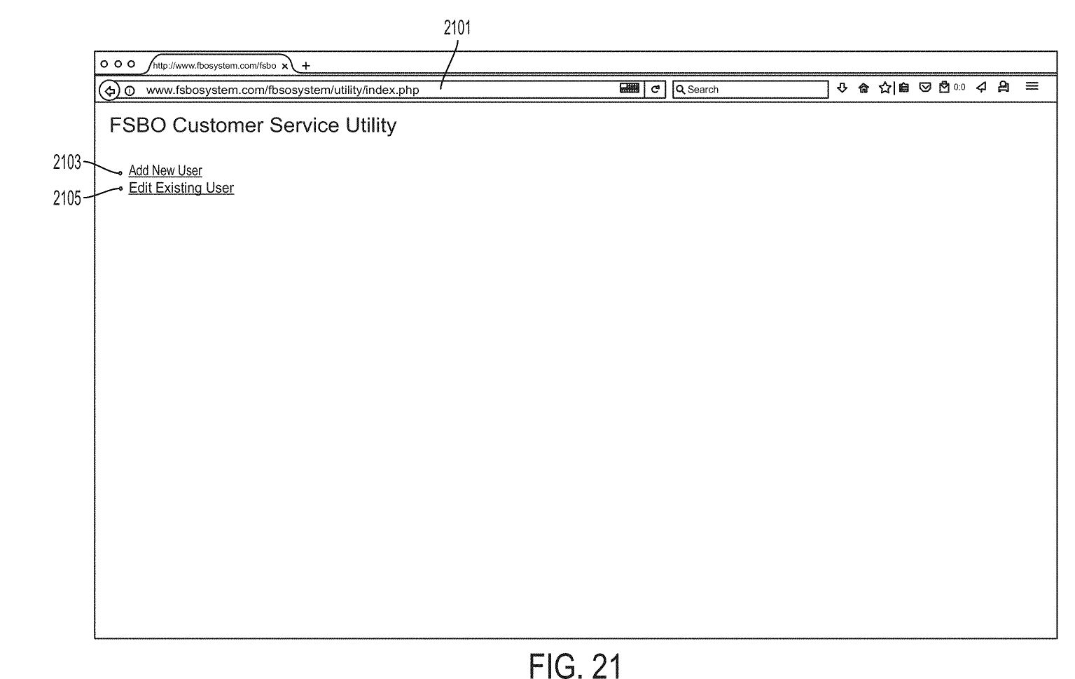

As illustrated in FIG. 21, in one embodiment, a counselor may navigate to a website 2101 via web browser 134 on GUI 132 of the counselor device 130. In one embodiment, the website 2101 may display a webpage that provide means for the counselor to interact with the CSU 164. For example, the webpage of the website 2101 may include link 2103 to add a new user and/or link 2105 to edit an existing user. In one embodiment, a seller may be the seller associated with the real estate transaction systems and methods described herein.

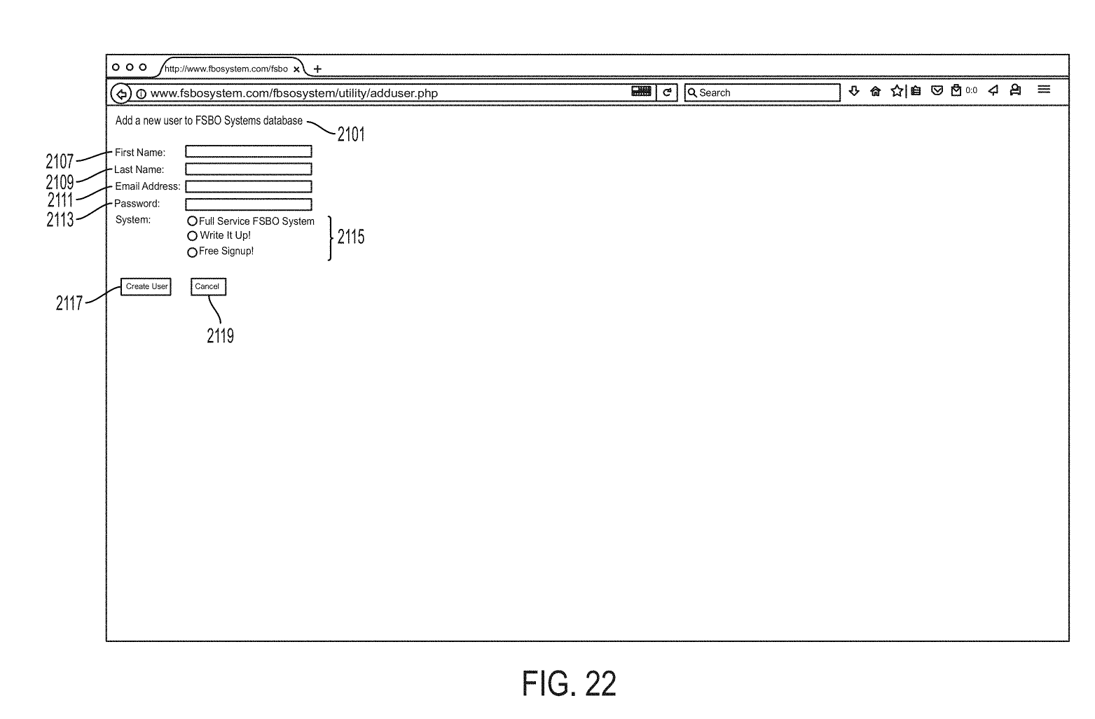

In one embodiment, a counselor may add a new seller associated with the real estate transaction systems and methods described herein. For example, as illustrated in FIG. 22, upon selecting add a new user link 2103 in FIG. 21, the webpage of website 2101 may update to display one or more fields configured to receive information regarding a new user. In one embodiment the counselor may input a first name in field 2107, last name in field 2109, email address in field 2111, and password in field 2113 associated with the seller. In one embodiment, the counselor may create different types of accounts via selectors 2115. Upon selecting the create user button 2117 of the webpage of website 2101, an account may be created in the database 170 in connection with the created user (i.e., seller). In one embodiment, the database 170 may be a MySQL database or similar data structure. In one embodiment, only after a counselor enters the information related to the seller, may server 160 provide access to the seller and/or permit the seller to provide data and information to the CSU 164 via the online interactive tutorial 162. In one embodiment, the online interactive tutorial may display the MySQL data for each user using dynamic Hypertext Preprocessor (PHP) via the CSU 164.

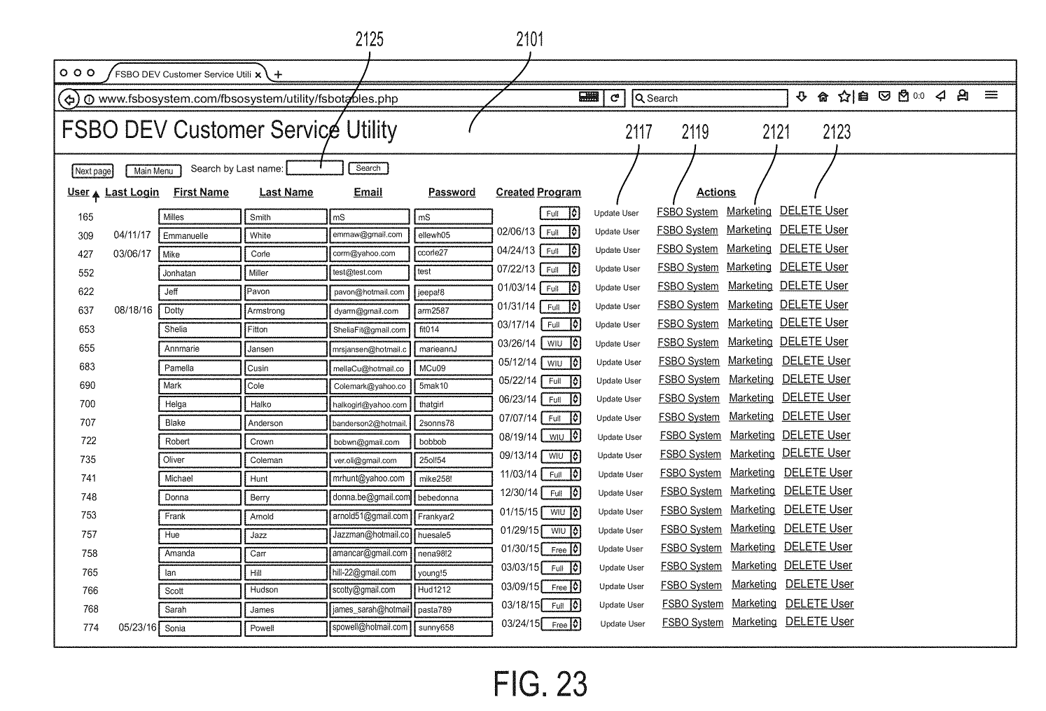

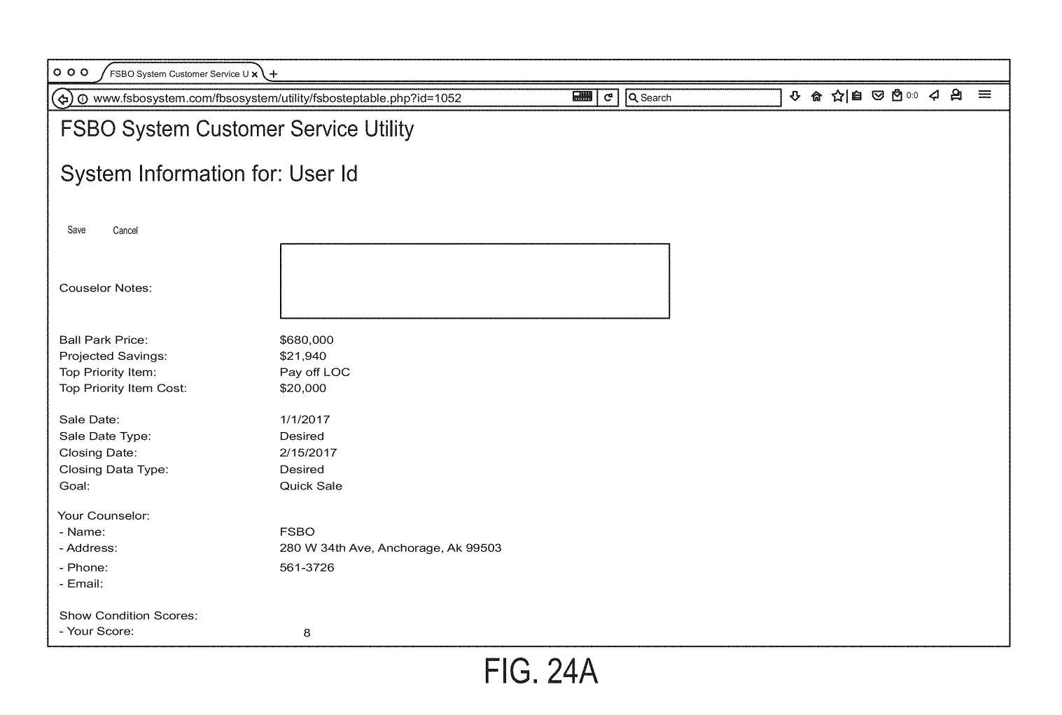

In one embodiment, a counselor may edit an existing seller record associated with the real estate transaction systems and methods described herein. For example, as illustrated in FIG. 23, upon selecting edit an existing user link 2105 in FIG. 21, the webpage of website 2101 may update to display the one or more users of the real estate transaction system stored in the database 170. User information may be displayed in the webpage of website 2101 including user index, last login, first name, last name, email, password, date when the account was created, and the account type. From the user information webpage of website 2101 the counselor may update information regarding the seller 2117, retrieve information related to the user's progress in the Real Estate Transaction link 2119, Marketing Information for the seller in link 2121, or delete the record via 2123 from the database 170 corresponding to the user. Optionally, the webpage of website 2101 may include a function 2125 to search the users by last name.

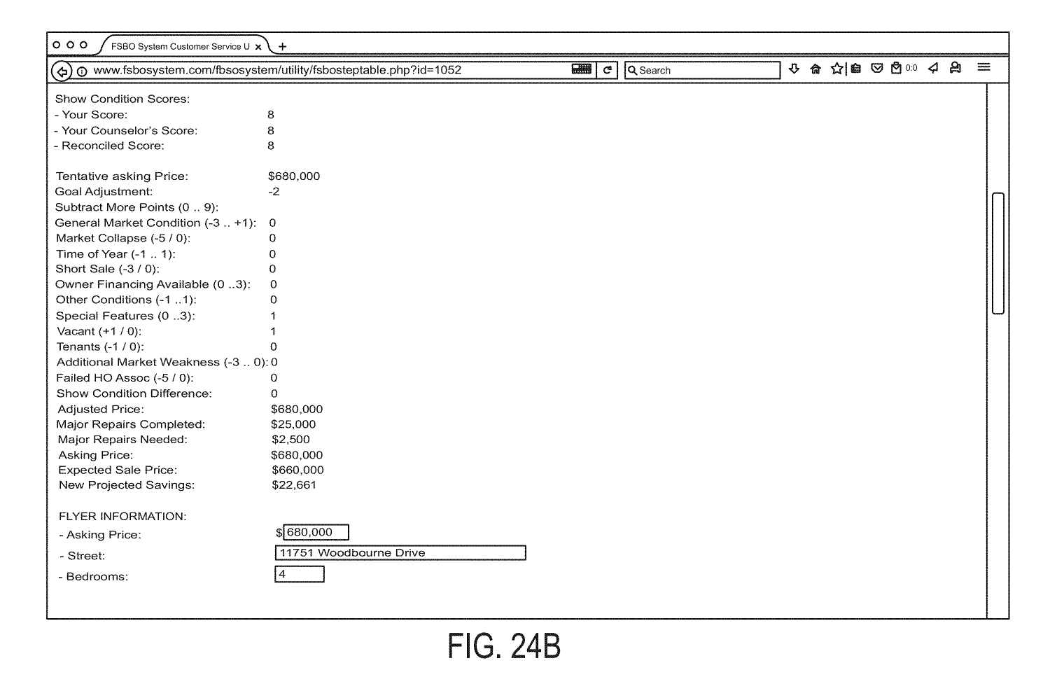

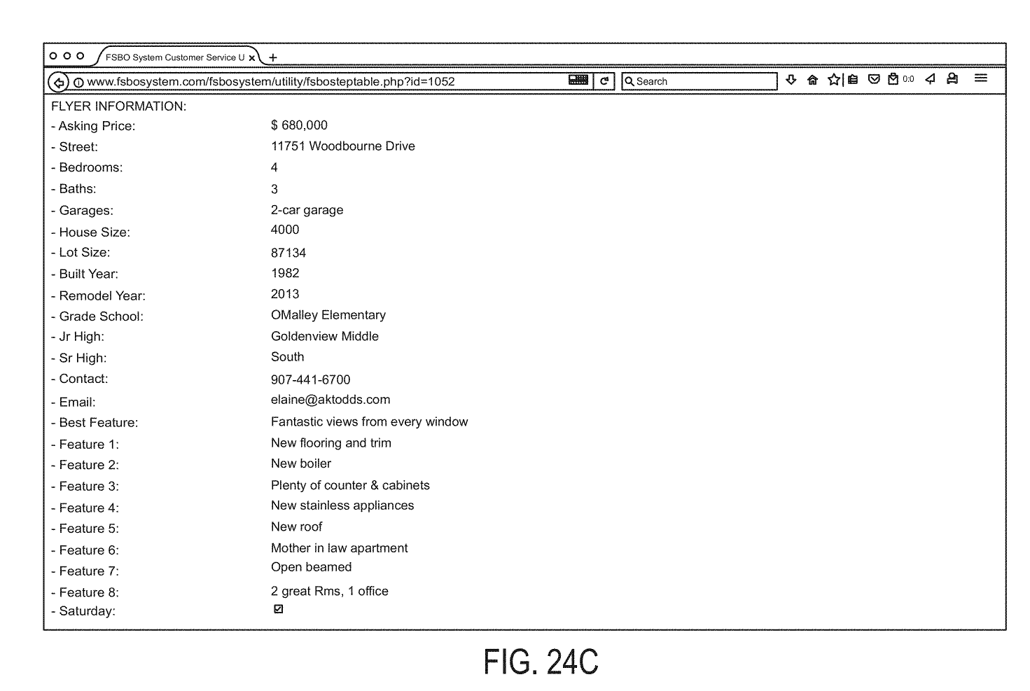

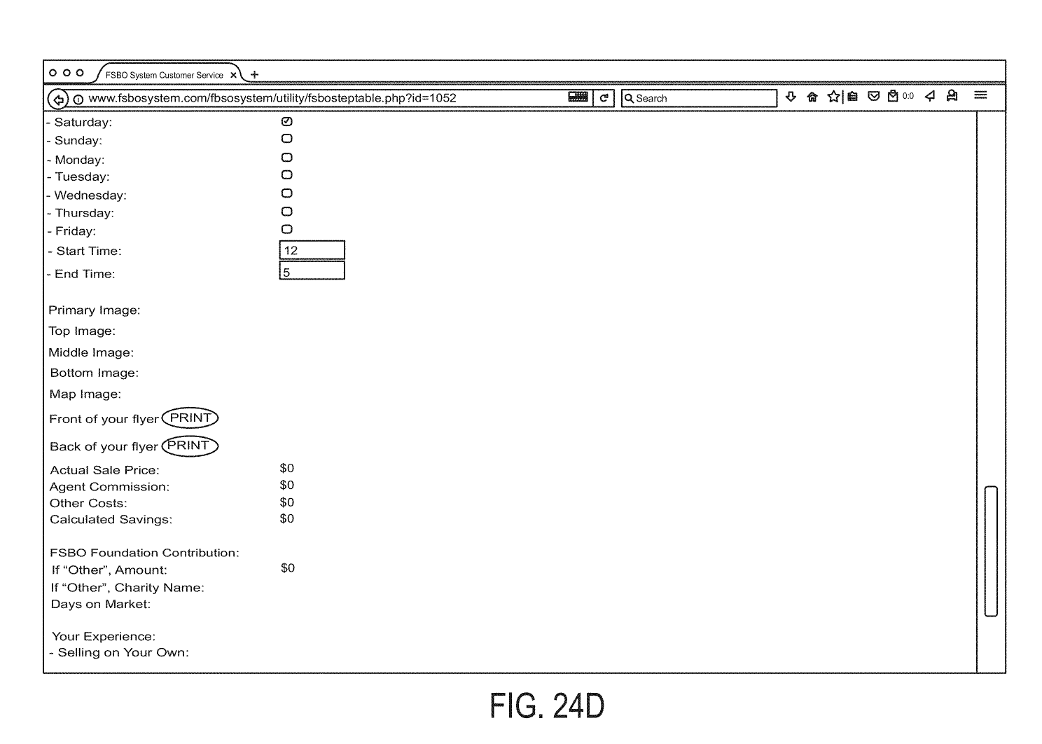

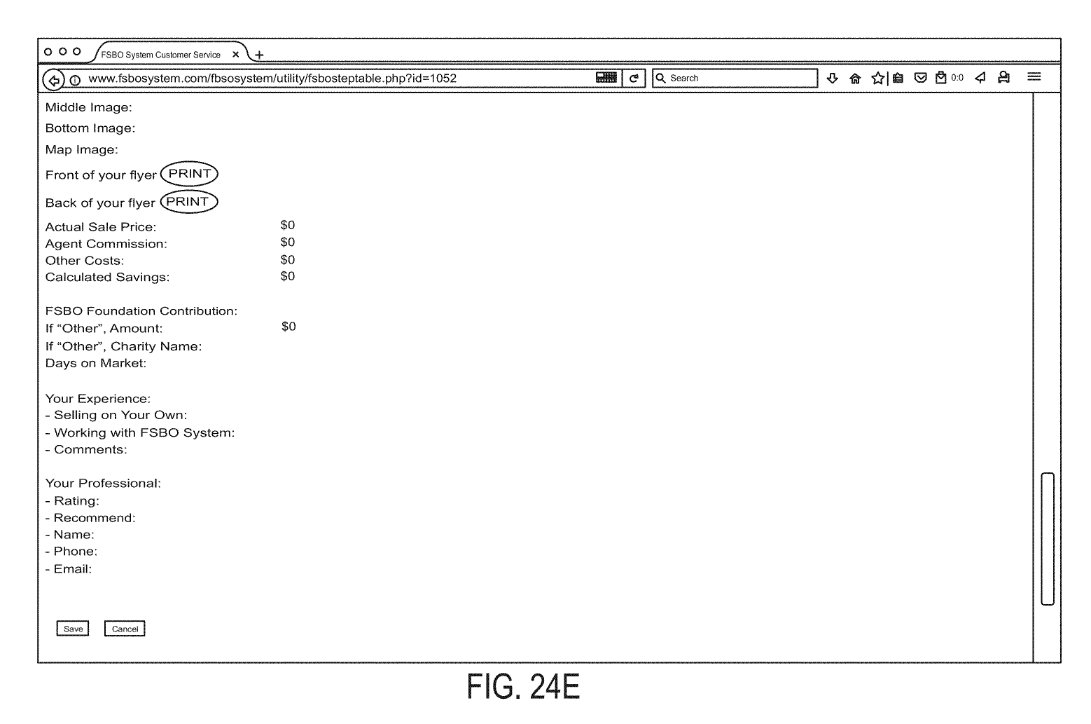

In one embodiment, as illustrated in FIGS. 24A-24E the counselor may view the user's progress in the Real Estate Transaction 2119. One or more the fields illustrated in FIGS. 24A-24E may be editable by the counselor. The fields may include information received from the seller in connection with the online interactive tutorial 162. For example, the following information related to the real estate transaction may be included: counselor's notes, ball park price, projected savings, top priority item (goal), top priority cost (goal's cost), sale date, sale date type, closing date, closing date type, goal, seller name, seller address, seller contact information, seller phone, seller email, show condition score, show condition score (as entered by a third party, e.g., the counselor), reconciled show condition score, tentative asking price, goal adjustment factor (factor 1 for adjusted CMA, factor 2 for adjusted CMA), general market condition including market collapse, time of year, short sale, owner financing available, other conditions, special features, vacancy, tenancy, additional market weakness, failed home owners association, show condition difference, adjusted price, major repairs completed, major repairs needed, asking price, expected sale price, projected savings, flyer information (including address, exterior and interior photographs, asking price, street address, bedrooms, bathrooms, garages, house size, lot size, built year, remodel year, grade school, junior high school, senior high school, contact email, best features, other features, days/times available for regularly scheduled open houses), primary image of the real estate property, map image, front of flyer, back of flyer, actual sale price, agent commission, other costs, calculated savings, foundation contributions, days on market, user feedback regarding selling on own (i.e., without an agent), selling with real estate transaction system 100, and counselor reviews. One or more of the fields may be automatically populated based on information received by the CSU 164 and/or calculated by the computational modules 165.

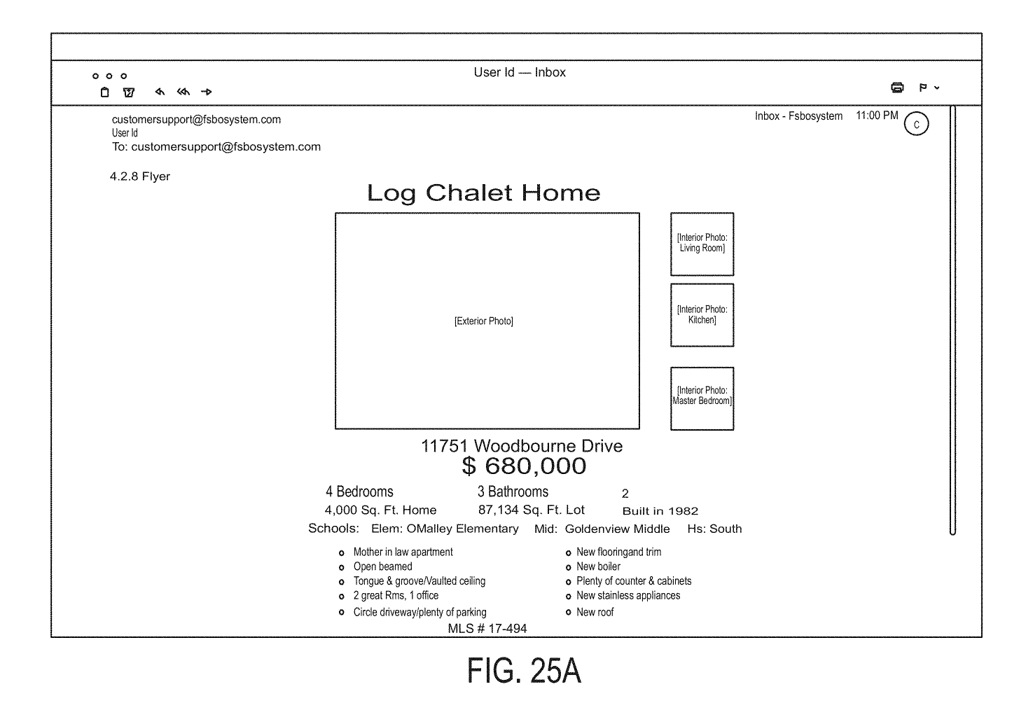

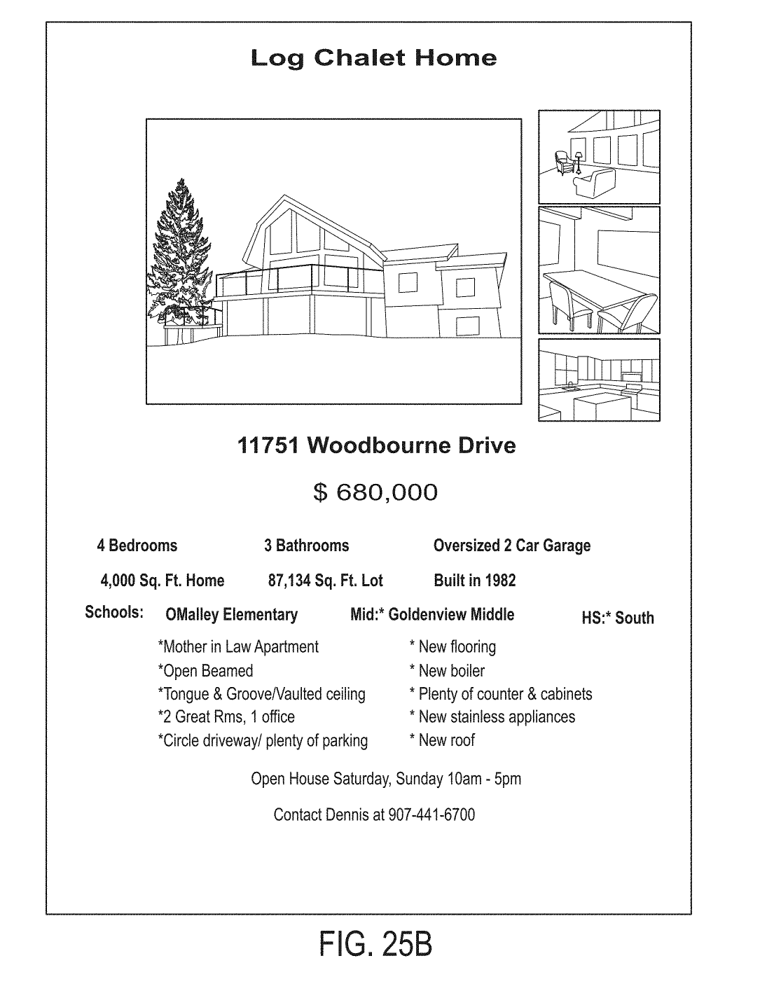

As illustrated in FIG. 25A, in one embodiment, a counselor may automatically receive an email at the counselor device 130 when a seller has uploaded or entered data and information into the online interactive tutorial 162 corresponding to one or more of the steps and/or sub-steps described above. For example, upon receiving data and information at the online interactive tutorial 162 from the seller, related to creating a flyer, the seller may create a flyer (according to the seller's input) that is then transmitted to the counselor via email. As illustrated, the flyer may be provided to the counselor device 130 in the text of the email. Alternatively, a link to an electronic file may be provided to counselor device 130. An example flyer is depicted in FIG. 25B.

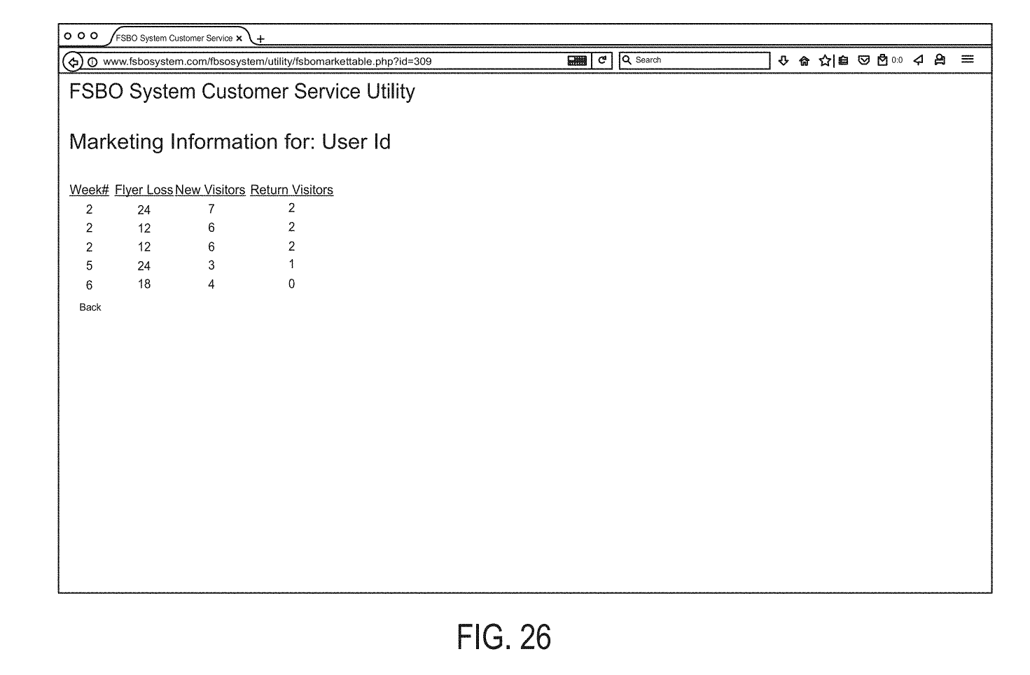

FIG. 26 illustrates a webpage available to a counselor via counselor device 130. As illustrated, upon selecting Marketing Information for the seller via link 2121 in FIG. 23, the dashboard or GUI 132 may be updated with marketing information regarding the user. The displayed marketing information may include values computed by the computational modules 165 of the server 160 including, for example, the flyer loss, new visitors, return visitors, and any suitable related statistics.

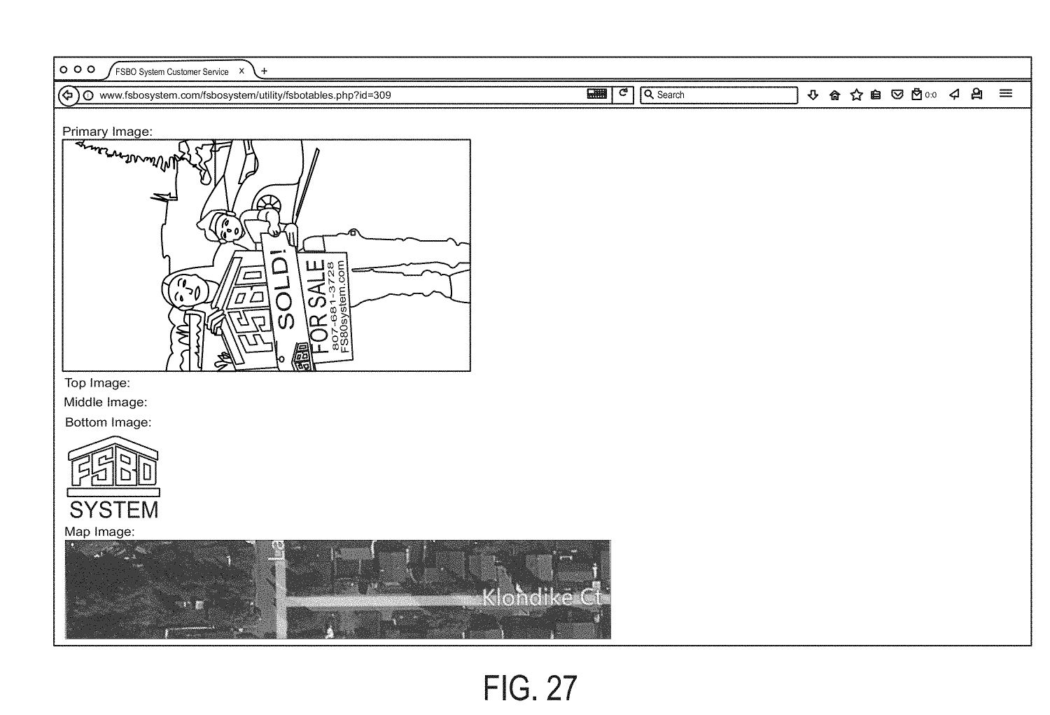

FIG. 27 also illustrates a webpage available to a counselor via counselor device 130. As discussed above, in one embodiment, the seller may upload one or more images related to the closing and provide feedback regarding their experiences with the online interactive tutorial. The images and feedback uploaded by the seller to the online interactive tutorial 162 via seller device 110 may be transmitted to the server 160 and displayed to the counselor on the counselor dashboard 132.

In one embodiment, a third party service provider separate from the counselor may manage and maintain the seller accounts depicted in FIGS. 21-27.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some embodiments, computers may include processors, memories, data storage devices, and/or other commonly known or novel components. These components may be connected physically or through network or wireless links. Computers may also include software which may direct the operations of the aforementioned components. Computers may be referred to with terms that are commonly used by those of ordinary skill in the relevant arts, such as servers, personal computers (PCs), mobile devices, and other terms. It should be understood that those terms used herein are interchangeable, and any special purpose computer capable of performing the described functions may be used.

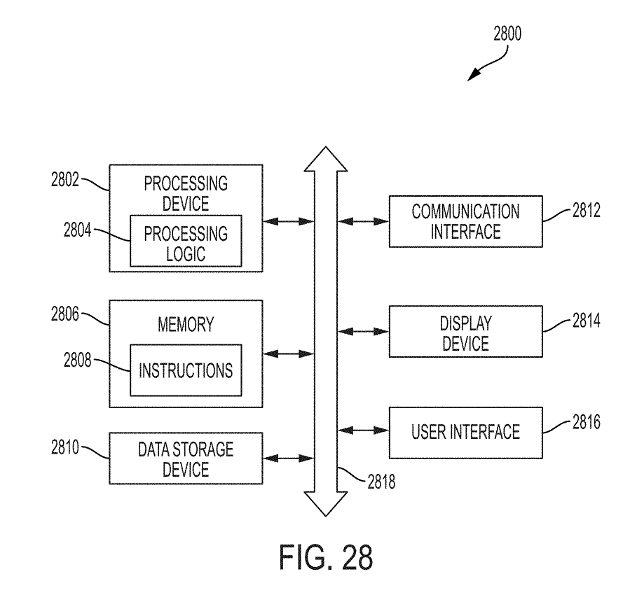

FIG. 28 illustrates a functional block diagram of a machine in the example form of computer system 2800 within which a set of instructions for causing the machine to perform any one or more of the methodologies, processes or functions discussed herein may be executed. In some examples, the machine may be connected (e.g., networked) to other machines as described above. The machine may operate in the capacity of a server or a client machine in a client-server network environment, or as a peer machine in a peer-to-peer (or distributed) network environment. The machine may be any special-purpose machine capable of executing a set of instructions (sequential or otherwise) that specify actions to be taken by that machine for performing the functions describe herein. Further, while only a single machine is illustrated, the term “machine” shall also be taken to include any collection of machines that individually or jointly execute a set (or multiple sets) of instructions to perform any one or more of the methodologies discussed herein. In some examples, each of the seller device 110, counselor device 130 and server 160 may be implemented by the example machine shown in FIG. 28 (or a combination of two or more of such machines).

Example computer system 2800 may include processing device 2802, memory 2806, data storage device 2810 and communication interface 2812, which may communicate with each other via data and control bus 2818. In some examples, computer system 2800 may also include display device 2814 and/or user interface 2816.

Processing device 2802 may include, without being limited to, a microprocessor, a central processing unit, an application specific integrated circuit (ASIC), a field programmable gate array (FPGA), a digital signal processor (DSP) and/or a network processor. Processing device 2802 may be configured to execute processing logic 2804 for performing the operations described herein. In general, processing device 2802 may include any suitable special-purpose processing device specially programmed with processing logic 2804 to perform the operations described herein.

Memory 2806 may include, for example, without being limited to, at least one of a read-only memory (ROM), a random access memory (RAM), a flash memory, a dynamic RAM (DRAM) and a static RAM (SRAM), storing computer-readable instructions 2808 executable by processing device 2802. In general, memory 2806 may include any suitable non-transitory computer readable storage medium storing computer-readable instructions 2808 executable by processing device 2802 for performing the operations described herein. Although one memory device 2808 is illustrated in FIG. 28, in some examples, computer system 2800 may include two or more memory devices (e.g., dynamic memory and static memory).

Computer system 2800 may include communication interface device 2812, for direct communication with other computers (including wired and/or wireless communication) and/or for communication with network 140 (see FIG. 1). In some examples, computer system 2800 may include display device 2814 (e.g., a liquid crystal display (LCD), a touch sensitive display, etc.). In some examples, computer system 2800 may include user interface 2816 (e.g., an alphanumeric input device, a cursor control device, etc.).

In some examples, computer system 2800 may include data storage device 2810 storing instructions (e.g., software) for performing any one or more of the functions described herein. Data storage device 2810 may include any suitable non-transitory computer-readable storage medium, including, without being limited to, solid-state memories, optical media and magnetic media.

### Definitions

It may be useful to define several terms used in relation the systems and methods described herein. It should be appreciated that the following definitions are used throughout this application. Where the definition of terms may depart from a commonly used meaning of the term, the definitions provided below are used, unless specifically indicated.

The term “Agent” refers to an individual or group of individuals that represent(s) the interests of one or more parties to the real estate transaction. An agent may include a licensed real estate professional and be referred to as a Real Estate Agents, Real Estate Broker, Real Estate Salesperson, Real Estate Associate Broker, and the like. Responsibilities of an agent may include transferring information and communicating between the parties involved in the real estate transaction. An agent may be bound by fiduciary and common law duties related to confidentiality, accounting and the like as is imposed by their licensing organization.

The term “Agent-Driven Process or Model” refers to a traditional real estate transaction having a designated agent for the seller (i.e., the listing agent) and a designated agent for the buyer (i.e., the buyer's agent). In some embodiments, a single agent may be designated as both the listing agent and the buyer's agent.

The term “Buyer focused computational utility” may refer to a computational module that is configured to receive and process feedback from prospective buyers with regards to the seller's marketing process. In one embodiment, the buyer focused computational utility may obtain data for at least one of the following metrics: marketing effectiveness, pricing viability, and likeability. Metrics for marketing effectiveness may be obtained by measuring flyer loss from a brochure box present on the real estate property. Metrics related to pricing viability may be obtained by determining the number of visitors to an open house for the property. Metrics related to the likeability of the house may be measured by determining the number of repeat visitors to the open house. The feedback received by the Buyer Focused Computational Utility may provide data and information needed to make mid-course corrections in the seller's marketing strategy.

The term “Buyer's Agent” refers to an agent (described above) representing the interests of a Buyer to the real estate transaction. Commonly, the Buyer's agent may share at least a portion of the Seller's Agent's commission.

The term “Comparative Market Analysis” (CMA) refers to a compilation of active listings and recent sales of closely comparable homes. The data and information presented in the CMA provides an objective range of asking prices, a seller may use to price their real estate property. In an exemplary embodiment, the interactive system described herein may provide the CMA to the seller, and a counselor affiliated with the interactive system may assist the seller in determining a list price for the real estate property.

The term “Commission” refers to a payment made by one or more of the seller and the buyer to one or more of the agent(s) at the closing of the transaction. Accordingly, the Commission is often contingent upon the transaction closing. In conventional residential real estate transactions, the commission is typically 6%, split evenly between the seller's agent and the buyer's agent. Additionally, in conventional residential real estate transactions the entire commission is provided by the seller.

The term “Commission to Selling Office” (CSO) refers to the portion of the commission (defined above) that is offered to all agents belonging to the MLS. In other words, it is the amount the seller's agent will pay another agent for their services including, for example, bringing a buyer for the house. The Commission to Selling Office is payable out of the seller's agent's commission at closing. Thus, the buyer's agent is paid by the seller's agent, and indirectly by the seller.

The term “Customer Support Utility” (CSU) refers to CSU 164 of system 100 that forms a “back end” of the interactive web-based guide for conducting real estate transactions described herein. The CSU 164 may receive, store and process data related to the seller's real estate transaction including (but not limited to) the metrics of the Buyer Focused Computational Utility 168, Comparative Market Analysis and the like. The data and information received, stored, and processed by the CSU 164 may be transmitted to one or more external computing systems (e.g., counselor device 130) for use by a counselor. As discussed above, the CSU 164 may communicate with GUI 132 of counselor device 130 to provide information to a counselor, such that the counselor may communicate and provide information to a seller. In some examples the CSU may perform calculations, analysis, or output functions.

The term “counselor” refers to a specially-trained, real estate professional who assists the seller in selling their home. In one embodiment, counselors may be licensed by a state, and may be members of the Board of Realtors. In one embodiment, counselors may be different from agents.

The terms “EZ Form Purchase and Sale Agreement” or “Easy Form Purchase and Sale Agreement” may refer to a purchase and sale agreement used by buyers and/or sellers, that is streamlined, and may be provided by an embodiment of the disclosure described herein. In particular, the EZ Form Purchase and Sale Agreement may be used when there is no agent for the buyer.

The systems and methods described herein refer to processing real estate transactions without either a seller's agent or a buyer's agent. Rather, in some embodiments the real estate transaction may occur with assistance from a licensed, specially-trained counselor.

The term “Latent Defect” refers to a defect in a real estate property that is not visible or discernable from simple observation. However, the evidence of the latent defect is often observable. For example, the latent defect of a damaged roof may not be visible, however, water damage to interior drywall may be evidence of a leaking roof.

The term “List Side” refers to the agent(s) and seller(s) who list their real estate property on MLS. The agent for the seller works on the “list side” of the transaction, and earns the “list side” of the commission—the full commission less the CSO.

The term “Listing Agent” refers to the agent who lists the property on the MLS system, and is an agent representing the interests of the seller.

The term “Multiple Listing Service” (MLS) refers to an organization owned and managed by real estate brokerage firms. Originally established almost a hundred years ago, the MLS also refers to the process by which a broker advertised their listings to other brokers, and offered a portion of her commission—the CSO—to other brokers who bring a buyer and close the transaction. Originally, the MLS published a catalogue of listings. With the advent of the Internet and powerful search engine software, the MLS became a home listing website for buyers to use. With the further advent of Internet Data Exchange (IDX) feed software, the national home-listing websites like Realtor.com, Zillow and Trulia, now automatically access and republish the MLS home listings. In this application, a reference to the MLS may include these other home-listing websites.

The term “Realtor®” refers to a real estate licensee who is member of the local Board of Realtors, a trade group, and through that, the state association of Realtors and the National Association of Realtors. Only about half of all licensees are Realtors. In one embodiment, the counselors of the methods and systems described herein are Realtors. Realtors subscribe to a Code of Ethics and receive special training.

The term “Sell Side” refers to the agent and side of the transaction representing the interests of the buyer. The agent on the sell side of the transaction receives the CSO (described above).

The term “Show Condition” refers to the condition of the real estate property when it is displayed to potential buyers. A property in “good” show condition may receive one or more offers for the property. However a property in “poor” show condition may receive few, if any, offers for the property. It may be recommended, that to achieve a “good” show condition, a seller may empty out the house, may make any needed repairs, and may otherwise place the property in show condition before creating an. In system 100, the seller and the counselor, may score the show condition of the property (e.g., from 1-10), before the property goes on the market.

The term “Staging” refers to removing the seller's possessions and furnishings from a house, and then refilling furnishings selected by a decorator called a “stager.” Staging is often recommended by agents, but may not be recommended by the system and methods described herein.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

1. A system comprising:
a first device comprising a first graphical user interface and a first web browser;
a second device comprising a second graphical user interface and a second web browser; and
at least one server communicatively coupled to the first device and the second device via a network, the at least one server comprising a non-transitory memory storing computer-readable instructions and at least one processor, execution of the instructions, by the at least one processor, causing the at least one server to:
provide one or more web pages to the first graphical user interface of the first device via the first web browser corresponding to an interactive tutorial of the at least one server for guiding a real estate transaction process;
receive, via the first web browser, input from the first device associated with the one or more web pages provided to the first graphical user interface;
identify, via a utility application embedded in the interactive tutorial, at least a portion of information from the received input matching one or more predetermined conditions; and
provide one or more further web pages including the identified portion of information to the second graphical user interface of the second device via the second web browser corresponding to a dashboard for monitoring the real estate transaction process of the first device.

2. The system of claim 1, wherein the at least one server is further configured to:
receive further input from the second device responsive to the one or more further web pages provided to the second graphical user interface; and
at least one of update the one or more web pages provided to the first graphical user interface based on the received further input and store at least a portion of the received further input on a database communicatively coupled to the at least one server.

3. The system of claim 1, further comprising at least one database communicatively coupled to the at least one server, the server configured to store the received input from the first device on the at least one database.

4. The system of claim 1, wherein the at least one server further comprising one or more computational modules, wherein the customer service utility is further configured to:
provide the one or more computational modules at least a portion of the received input from the first device, wherein the computational modules are further configured to:
receive at least a portion of the received input from the first device,
determine at least one value by performing at least one computational function, and
provide the at least one value to the customer service utility, and
at least one of:
update the one or more web pages provided to the first graphical user interface based on the computed at least one value,
update the one or more further web pages provided to the second graphical user interface based on the computed at least one value, and
store the computed at least one value in at least one database communicatively coupled to the at least one server.

5. The system of claim 4, wherein the at least one value is at least one of a compensation, a seller's savings, a target closing date, a target on market date, a target sale date, a show condition, a comparative market analysis value, an adjusted comparative market analysis value, one or more adjustment factors, a price adjustment weight, a number of days on market, a flyer loss, a number of visitors, a number of return visitors, a viability of asking price ratio, and a show condition ratio.

6. The system of claim 3, wherein the one or more computational modules comprises a seller focused computational utility configured to determine at least one of a compensation, a seller's savings, a target closing date, a target on market date, a target closing date, a show condition, a comparative market analysis (CMA) value, an adjusted comparative market analysis (adjusted CMA) value, a price adjustment weight, a baseline comparative market analysis (baseline CMA) value, and a days on market value.

7. The system of claim 3, wherein the one or more computational modules comprises a buyer focused computational utility configured to determine the at least one value based on at least one of a flyer loss, a number of visitors, and a number of return visitors.

8. The system of claim 1, wherein the one or more predetermined conditions are reflective of one or more of user input, seller information, property information, pricing information, real estate transaction information, marketing information, and process feedback information.

9. The system of claim 1, wherein the interactive tutorial is further configured to provide guidance, via the one or more web pages, related to at least one of a planning ahead process, a show condition process, an asking price process, a marketing material production process, buyer process, a negotiation process, and a closing process.

10. The system of claim 1, further comprising one or more data sources communicatively coupled to the first device and the second device and configured to provide reference data and information related to one or more real estate properties.

11. The system of claim 1, wherein one or more of the first device, the second device, and the at least one server further comprises a printing device.

12. The system of claim 1, wherein the interactive tutorial is further configured to at least one of:
provide, via the one or more web pages, to the first device, at least one of video, audio, electronic documentation, links to another web page, links to legal documentation, downloadable documents, text, and graphics; and
receive, from the first device, at least one of text input, selections, document uploads, photographs, images, video, and audio.

13. The system of claim 1, wherein the dashboard is further configured to at least one of:
provide, via the one or more further web pages, to the second device, at least one of video, audio, electronic documentation, links to another web page, links to legal documentation, downloadable documents, text, email, graphics, photographs, images, video, and audio; and
receive, from the second device, at least one of text input, selections, document uploads, photographs, images, video, and audio.

14. The system of claim 1, wherein the customer service utility automatically creates an electronic notification and transmits the electronic notification to the second device upon identifying that at least one of the one or more predetermined conditions has been met.

15. The system of claim 1, wherein the second device is further configured to:
receive a request for creating an account from a user of the first device, and
create, via the utility application, an account for the user of the first device based on the received request.

16. The system of claim 1, wherein the at least one server is further configured to:
automatically create an electronic flyer based on input received from at least one of the first device and the second device.

17. A computer-implemented method comprising:
providing a system comprising a first device, a second device, and at least one server, wherein the first device further comprises a first graphical user interface and a first web browser, the second device further comprises a second graphical user interface and a second web browser, and the at least one server is communicatively coupled to the first device and the second device via a network, the at least one server comprising a non-transitory memory storing computer-readable instructions and at least one processor;
providing, by the at least one server, one or more web pages to the first graphical user interface of the first device via the first web browser corresponding to an interactive tutorial of the at least one server for guiding a real estate transaction process;
receiving, by the first device, via the first web browser, input associated with the one or more web pages provided to the first graphical user interface;
identifying, by the at least one server, via a utility application embedded in the interactive tutorial, at least a portion of information from the received input matching one or more predetermined conditions; and
providing, by the at least one server, one or more further web pages including the identified portion of information to the second graphical user interface of the second device via the second web browser corresponding to a dashboard for monitoring a transaction process of the first device.

18. The method of claim 17, further comprising
receiving, by the at least one server, further input from the second device responsive to the one or more further web pages provided to the second graphical user interface; and
at least one of:
updating, by the at least one server, the one or more web pages provided to the first graphical user interface based on the received further information, and
storing, by the at least one server, at least a portion of the received further input on a database communicatively coupled to the at least one server.

19. The method of claim 17, the method further comprising storing the received input from the first device on at least one database communicatively coupled to the at least one server.

20. The method of claim 17, where the at least one server further comprises one or more computational modules, the method further comprising:
providing, by the customer service utility, the one or more computational modules at least a portion of the input from the first device;
receiving, by the one or more computational modules, at least a portion of the received input from the first device;
determining, by the one or more computational modules, at least one value by performing at least one computational function;
providing, by the one or more computational modules, the at least one value to the customer service utility; and
at least one of:
updating, by the customer service utility, the one or more web pages provided to at least one of the first graphical user interface based on the computed at least one value,
updating, by the customer service utility, the one or more further web pages provided to the second graphical user interface based on the computed at least one value; and
storing, by the customer service utility, the computed at least one value in at least one database communicatively coupled to the at least one server.

21. The method of claim 20, wherein the computed at least one value is at least one of a compensation, a seller's savings, a target closing date, a target on market date, a target sale date, a show condition, a comparative market analysis value, an adjusted comparative market analysis value, one or more adjustment factors, a price adjustment weight, a number of days on market, a flyer loss, a number of visitors, a number of return visitors, a viability of asking price ratio, and a show condition ratio.

22. The method of claim 19, wherein the one or more computational modules comprises a seller focused computational utility, the method further comprising:
determining, by the seller focused computational utility, at least one of a compensation, a seller's savings, a target closing date, a target on market date, a target closing date, a show condition, a comparative market analysis (CMA) value, an adjusted comparative market analysis (adjusted CMA) value, a price adjustment weight, a baseline comparative market analysis (baseline CMA) value, and a days on market value.

23. The method of claim 19, wherein the one or more computational modules comprises a buyer focused computational utility, the method further comprising:
determining, by the buyer focused computational utility, the at least one value based on at least one of a flyer loss, a number of visitors, and a number of return visitors.

24. The method of claim 17, wherein the one or more predetermined conditions are reflective of one or more of user input, seller information, property information, pricing information, real estate transaction information, marketing information, and process feedback information.

25. The method of claim 17, further comprising:
providing, via the one or more web pages of the interactive tutorial, guidance related to at least one of a planning ahead process, a show condition process, an asking price process, a marketing material production process, a buyer process, a negotiation process, and a closing process.

26. The method of claim 17, further comprising:
providing, by one or more data sources communicatively coupled to the first device and the second device, reference data and information related to one or more real estate properties.

27. The method of claim 17, wherein one or more of the first device, the second device, and the at least one server further comprises a printing device.

28. The method of claim 17, further comprising:
providing, via the one or more web pages of the interactive tutorial, to the first device, at least one of video, audio, electronic documentation, links to another web page, links to legal documentation, downloadable documents, text, and graphics; and
receiving, from the first device, via the one or more webpages of the interactive tutorial, at least one of text input, selections, document uploads, photographs, images, video, and audio.

29. The method of claim 17, further comprising:
providing, via the one or more further web pages of the dashboard, to the second device, at least one of video, audio, electronic documentation, links to another web page, links to legal documentation, downloadable documents, text, email, graphics, photographs, images, video, and audio; and
receiving, from the second device via the one or more web pages of the dashboard, at least one of text input, selections, document uploads, photographs, images, video, and audio.

30. The method of claim 17, further comprising:
automatically creating, by the at least one server, an electronic notification; and
transmitting, by the at least one server, the electronic notification to the second device upon identifying that at least one of the one or more predetermined conditions has been met.

31. The method of claim 17, further comprising,
automatically creating, via the at least one server, an electronic flyer based on input received from at least one of the first device and the second device.

32. A system comprising:
a first device comprising a first graphical user interface and a first web browser;
at least one server communicatively coupled to the first device via a network, the at least one server comprising a non-transitory memory storing computer-readable instructions and at least one processor, execution of the instructions, by the at least one processor, causing the at least one server to:
provide one or more web pages to the first graphical user interface of the first device via the first web browser corresponding to an interactive tutorial of the at least one server for guiding a real estate transaction process;
receive, via the first web browser, input from the first device associated with the one or more web pages provided to the first graphical user interface;
identify, via a utility application embedded in the interactive tutorial, at least a portion of information from the received input matching one or more predetermined conditions; and
store the identified portion of information in at least one database communicatively coupled to the at least one server.

33. The system of claim 32, further comprising:
a second device comprising a second graphical user interface and a second web browser, wherein the second device is communicatively coupled to the at least one server via the network; and
the execution of instructions by the at least one processor further causes the at least one server to:
provide one or more further web pages including the identified portion of information to the second graphical user interface of the second device via the second web browser corresponding to a dashboard for monitoring the real estate transaction process of the first device.

34. The system of claim 33, wherein the at least one server is further configured to:
receive further input from the second device responsive to the one or more further web pages provided to the second graphical user interface.

35. The system of claim 34, wherein the at least one server is further configured to:
update the one or more web pages provided to at least one of the first graphical user interface based on the received further input.

36. The system of claim 34, wherein the at least one server is further configured to:
store at least a portion of the received further input on the at least one database.

37. The system of claim 32, wherein the at least one server further comprising a seller focused computational utility configured to determine at least one of a compensation, a seller's savings, a target closing date, a target on market date, a target closing date, a show condition, a comparative market analysis (CMA) value, an adjusted comparative market analysis (adjusted CMA) value, a price adjustment weight, a baseline comparative market analysis (baseline CMA) value, and a days on market value.

38. The system of claim 36, wherein the at least one server further comprises a buyer focused computational utility configured to determine one or more values based on at least one of a flyer loss, a number of visitors, and a number of return visitors.

39. The system of claim 32, wherein the one or more predetermined conditions are reflective of one or more of user input, seller information, property information, pricing information, real estate transaction information, marketing information, and process feedback information.

40. The system of claim 32, wherein the interactive tutorial is further configured to provide guidance, via the one or more web pages, related to at least one of a planning ahead process, a show condition process, an asking price process, a marketing material production process, a buyer process, a negotiation process, and a closing process.

41. The system of claim 32, further comprising one or more data sources communicatively coupled to the first device configured to provide reference data and information related to one or more real estate properties.

42. The system of claim 33, wherein one or more of the first device, the second device, and the at least one server further comprises a printing device.

43. The system of claim 32, wherein the interactive tutorial is further configured to at least one of:
provide, via the one or more web pages, to the first device, at least one of video, audio, electronic documentation, links to another web page, links to legal documentation, downloadable documents, text, and graphics; and
receive, from the first device, at least one of text input, selections, document uploads, photographs, images, video, and audio.

44. The system of claim 33, wherein the dashboard is further configured to at least one of:
provide, via the one or more further web pages, to the second device, at least one of video, audio, electronic documentation, links to another web page, links to legal documentation, downloadable documents, text, email, graphics, photographs, images, video, and audio; and
receive, from the second device, at least one of text input, selections, document uploads, photographs, images, video, and audio.

45. The system of claim 33, wherein the customer service utility automatically creates an electronic notification and transmits the electronic notification the second device upon identifying that at least one of the one or more predetermined conditions has been met.

46. The system of claim 33, wherein the second device is further configured to:
receive a request for creating an account from a user of the first device, and
create, via the utility application, an account for the user of the first device based on the received request.

47. The system of claim 33, wherein the at least one server is further configured to:
automatically create an electronic flyer based on input received from at least one of the first device and the second device.
